(19) United States
(12) Patent Application Publication
(10) Pub. No.: US 2015/0161709 A1
(43) Pub. Date: Jun. 11, 2015

(54) POP-UP RECOMMENDATION LISTS

(71) Applicant: ZInc., Atlanta, GA (US)

(72) Inventors: Dennis L. Zakas, Atlanta, GA (US); Kevin Martin Hayes, Atlanta, GA (US); Tamara Peress Watkins, Palm Beach, FL (US)

(21) Appl. No.: 14/624,280

(22) Filed: Feb. 17, 2015

Related U.S. Application Data
(63) Continuation of application No. 13/411,561, filed on Mar. 3, 2012, now abandoned.
(60) Provisional application No. 61/449,605, filed on Mar. 4, 2011.

(51) Int. Cl. G06Q 30/06

(52) U.S. Cl. CPC G06Q 30/0631

(57) ABSTRACT

The present disclosure relates to providing sponsor content to an individual, providing a pop-up recommendation list that includes information referring to a plurality of items recommended to the individual, and enabling the individual to purchase at least one of the plurality of items recommended to the individual.

### CROSS-REFERENCE

This application is a continuation of U.S. application Ser. No. 13/411,561, filed Mar. 3, 2012, which claims the benefit of U.S. Provisional Application No. 61/449,605, filed Mar. 4, 2011, the entire disclosures of which are hereby incorporated by reference herein.

### TECHNICAL FIELD

The present disclosure generally relates to on-line retail transactions, and more particularly relates to systems and methods for recommending goods and/or services.

### BACKGROUND

As electronic commerce (i.e., online shopping) has become a ubiquitous and invaluable resource to today's consumers, merchants and vendors constantly seek new ways to maximize profits and revenues while attracting customers and providing optimum value. One way that merchants and vendors achieve this is by bundling products which may be purchased together at a price cheaper to the customer than purchasing the items individually. For instance, a customer interested in purchasing ski equipment may receiver lower prices from a vendor by buying all of the ski equipment together.

### SUMMARY

The present disclosure relates to systems and methods for recommending multiple goods and/or services. An exemplary embodiment includes providing sponsor content to an individual, providing a pop-up recommendation list that includes information referring to a plurality of items recommended to the individual, and enabling the individual to purchase at least one of the plurality of items recommended to the individual.

Various implementations described in the present disclosure may include additional systems, methods, features, and advantages, which may not necessarily be expressly disclosed herein but will be apparent to one of ordinary skill in the art upon examination of the following detailed description and accompanying drawings. It is intended that all such systems, methods, features, and advantages be included within the present disclosure and protected by the accompanying claims.

### BRIEF DESCRIPTION OF THE DRAWINGS

The features and components of the following figures are illustrated to emphasize the general principles of the present disclosure. Corresponding features and components throughout the figures may be designated by matching reference characters for the sake of consistency and clarity.

FIG. 1a illustrates a high level block diagram of a computer system on which the exemplary systems and methods for providing dynamic bundle systems, various types of concierge bundles described herein, the pricing engines optionally including bundle evaluation, the concierge bundle intelligence engine and pop-up recommendation lists may be implemented and/or accessed; although elements of the systems and methods can be used together, each element of the systems and methods is independent and can be used separately; the elements of the systems and methods are referred to collectively as the “elements” and individually as an “element;”

FIG. 1b illustrates a block diagram of the communication network through which the exemplary systems and methods for providing the elements may be accessed by one of a plurality of access devices;

FIG. 2a illustrates a high level work flow diagram of the exemplary systems and methods for definition and management of a dynamic bundle system by a vendor or retailer; and use of a dynamic bundle system by a primary customer;

FIGS. 2b-2g illustrate screen shots of exemplary systems and methods regarding the work flow diagram of FIG. 2a;

FIG. 3a illustrates a high level work flow diagram of the exemplary systems and methods regarding the definition and management of the various elements associated with concierge bundles by a vendor or retailer; and various uses of concierge bundles by primary customers;

FIGS. 3b-3f illustrate screen shots of exemplary systems and methods regarding the work flow diagram of FIG. 3a;

FIG. 4a illustrates a high level work flow diagram of the exemplary systems and methods regarding the definition and management of pop-up recommendations list (PURL) by a vendor, retailer, blogger, reseller, expert or other person and interaction with the recommendations lists by an customer;

FIGS. 4b and 4c illustrate screen shots of exemplary systems and methods regarding the work flow diagram of FIG. 4a;

FIG. 5a-5l illustrate a high level work flow for the multiple elements of the exemplary system and methods regarding the definition and management for the components of an overall dynamic bundle system.

### DETAILED DESCRIPTION

Set forth in the present disclosure is an overview of embodiments, implementations, and advancements related to the offering, purchasing, and sale of Bundles of goods or services in one or a series of transactions. The embodiments enable vendors to make bundles available to customers and enable customers to create and/or modify their own bundles. Bundles are created, presented and/or modified electronically through Interfaces. Dynamic bundle systems are automated and perform pricing and presentment almost immediately after the customer submits to the vendor a modification of a bundle or a proposed bundle. Aside from setting pre-determined rules, little (if any) human action on the vendor side is required to price a customer-modified or varied bundle.

Embodiments of the present disclosure are directed to systems and methods for providing dynamic bundles, various types of concierge bundles described herein, the pricing engines, the concierge bundle intelligence engine and pop-up recommendation lists, which may be implemented and/or accessed by various parties. Although elements of the systems and methods can be used together, each element of the systems and methods is independent and can be used separately; the elements of the systems and methods are referred to collectively as the “elements” and individually as an “element.” In addition, each of the elements may be viewed as an independent system and method. Those skilled in the art will recognize that each of the elements can be utilized in various platforms and/or technical devices.

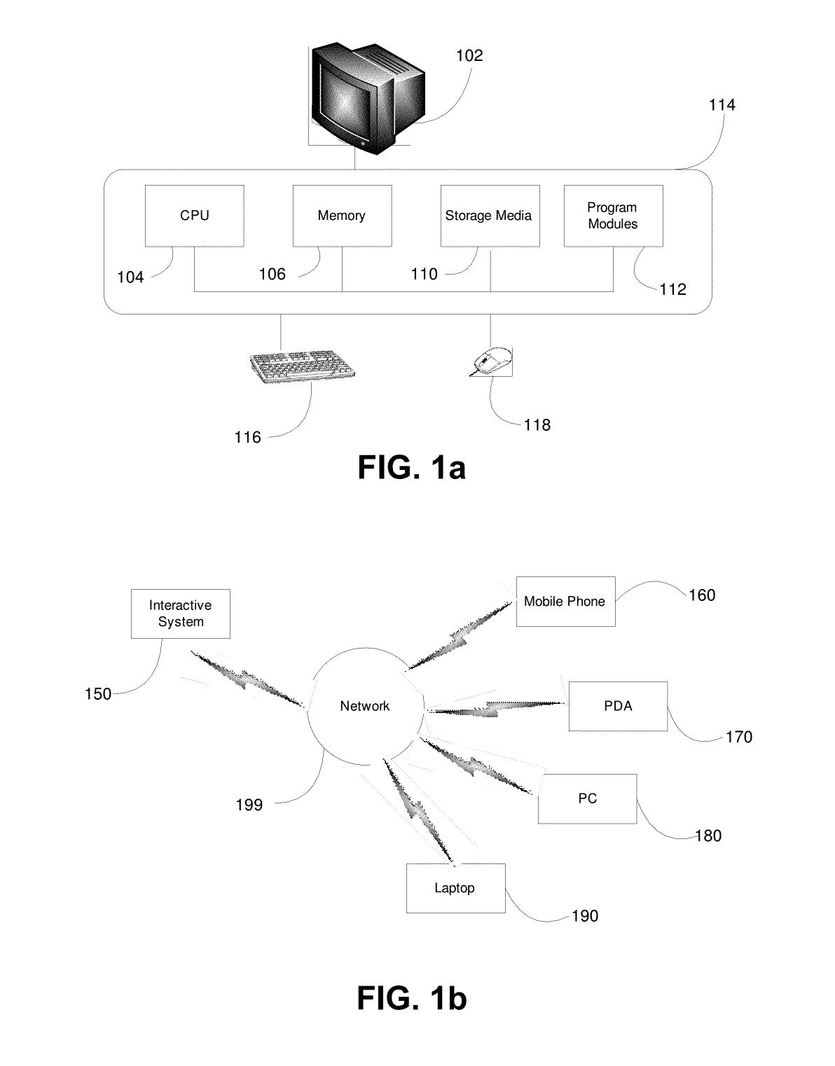

FIG. 1a shows an embodiment of a computer system 114 that enables a customer to access the systems and methods for bundling goods and/or services, and FIG. 1b shows a communication network 199 enabling communication between various computer systems.

Elements, combinations of Elements and systems including Elements may include instructions executed on a general purpose computer. Systems including one or more of the Elements may be included in computer system 114. Elements, combinations of Elements and systems including Elements may be described in the general context of computer-executable instructions, such as program modules 112, being executed by a general purpose computer. Generally, program modules 112 include routines, programs, objects, components, data structures, etc. that perform particular tasks. Although elements of the systems and methods can be used together, each element of the systems and methods is independent and can be used separately.

Those skilled in the art will appreciate that each of the systems and methods may be practiced with various general purpose computer system 114 configurations, including hand-held wireless devices such as mobile phones and/or smart phones 160 or PDAs 170, multiprocessor systems, personal computers 180, microprocessor-based or programmable consumer electronics, minicomputers, mainframe computers, laptops 190, desktops, netbooks, iPads, tablet PCs, and the like.

Each system and method may also be practiced in distributed computing environments where tasks are performed by remote processing devices that are linked through communications network 199. In a distributed computing environment, program modules 112 may be located in one or both of local and remote computer storage media 110 including memory storage devices.

The computer system 114 may include a general purpose computing device in the form of a computer including a central processing unit (CPU) 104, a system memory 106, and a system bus that couples various system components including the system memory 106 to the processing unit 104.

The computer system 114 may include a variety of computer readable media that can form part of the system memory 106 and be read by the CPU 104. By way of example and without limitation, computer readable media may comprise computer storage media 110 and communication media. The system memory 106 may include computer storage media 110 in the form of volatile and/or nonvolatile memory such as read only memory (ROM) and random access memory (RAM). A basic input/output system (BIOS), containing the basic routines that help to transfer information between elements, such as during start-up, is typically stored in ROM. RAM typically contains data and/or program modules that are immediately accessible to and/or presently being operated on by processing unit 104.

The data or program modules 112 may include an operating system, application programs, other program modules, and program data. The operating system may be or include a variety of operating systems such as Microsoft Windows® operating system, the Unix operating system, the Linux operating system, the Xenix operating system, the IBM AIX™ operating system, the Hewlett Packard UX™ operating system, the Novell Netware™ operating system, the Sun Microsystems Solaris™ operating system, the OS/2™ operating system, the BeOS™ operating system, the Macintosh™® operating system, the Apache™ operating system, the Android Operating System, an OpenStep™ operating system, or any other operating system or platform.

At a minimum, the memory 106 includes at least one set of instructions that is either permanently or temporarily stored. The CPU 104 executes the instructions that are stored in order to process data. The set of instructions may include various instructions that perform a particular task or tasks. Such a set of instructions for performing a particular task may be characterized as a program, software program, software, engine, module, component, mechanism, or tool.

Each system that includes one or more of the Elements of FIG. 1b may include a plurality of software processing modules stored in a memory 106 as described above and executed on a CPU 104 in the manner described herein. The program modules 112 may be in the form of any suitable programming language, which is converted to machine language or object code to enable the CPU 104 or other processors to read the instructions. That is, written lines of programming code or source code, in a particular programming language, may be converted to machine language using a compiler, assembler, or interpreter. The machine language may be binary coded machine instructions specific to a particular computer.

Any suitable programming language may be used in accordance with the various embodiments. Illustratively, the programming language used may include assembly language, Ada, APL, Basic, C, C++, COBOL, dBase, Forth, FORTRAN, Java, Modula-2, Pascal, Perl, Prolog, Python, Ruby, REXX, and/or JavaScript for example. Further, it is not necessary that a single type of instruction or programming language be utilized in conjunction with the operation of the systems and methods of the present disclosure. Rather, any number of different programming languages may be utilized as is necessary or desirable.

Also, the instructions and/or data used in the practice of the systems and methods may utilize any compression or encryption technique or algorithm, as may be desired. An encryption module might be used to encrypt data. Further, files or other data may be decrypted using a suitable decryption module.

The computing environment may also include other removable/nonremovable, volatile/nonvolatile computer storage media 110. For example, a hard disk drive may read or write to nonremovable, nonvolatile magnetic media. A magnetic disk drive may read from or writes to a removable, nonvolatile magnetic disk, and an optical disk drive may read from or write to a removable, nonvolatile optical disk such as a CD ROM or other optical media. Other removable/nonremovable, volatile/nonvolatile computer storage media 110 that can be used in the exemplary operating environment include, but are not limited to, magnetic tape cassettes, flash memory cards, digital versatile disks, digital video tape, solid state RAM, solid state ROM, and the like. The storage media 110 are typically connected to the system bus through a removable or non-removable memory interface.

The CPU 104 that executes commands and instructions may be a general purpose computer, but may utilize any of a wide variety of other technologies including a special purpose computer, a microcomputer, mini-computer, mainframe computer, programmed microprocessor, micro-controller, peripheral integrated circuit element, a CSIC (Customer Specific Integrated Circuit), ASIC (Application Specific Integrated Circuit), a logic circuit, a digital signal processor, a programmable logic device such as an FPGA (Field Programmable Gate Array), PLD (Programmable Logic Device), PLA (Programmable Logic Array), RFID integrated circuits, smart chip, or any other device or arrangement or combination of devices or processors that are capable of implementing the steps of the processes described herein. In some embodiments, the CPU 104 may comprise a plurality of processors or microprocessors.

It should be appreciated that the processors (e.g., CPU 104) and/or memories (e.g., memory 106) of the computer system 114 need not be physically in the same location. Each of the processors 104 and each of the memories 106 used by the computer system 114 may be in geographically distinct locations and be connected so as to communicate with each other in any suitable manner. Additionally, it is appreciated that each of the processor 104 and/or memory 106 may be composed of different physical pieces of equipment.

A customer may enter commands and information into the computer through a customer interface that includes input devices such as a keyboard 116 and pointing device 118, commonly referred to as a mouse, trackball or touch pad. Other input devices may include a microphone, joystick, motion sensor, game pad, satellite dish, scanner, voice recognition device, touch screen, toggle switch, pushbutton, or the like. These and other input devices are often connected to the CPU 104 through a customer input interface that is coupled to the system bus, but may be connected by other interface and bus structures, such as a parallel port, game port or a universal serial bus (USB).

One or more monitors 102 or display devices may also be connected to the system bus via an interface. In addition to display devices, the computer system 114 may also include other peripheral output devices, which may be connected through an output peripheral interface. The computer system 114 implementing the processes of the present disclosure may operate in a networked 199 environment using logical connections to one or more remote computers, the remote computers typically including many or all of the elements described above with respect to the computer system 114.

Various networks 199 may be implemented in accordance with various embodiments of the present disclosure, including a wired or wireless local area network (LAN), a wide area network (WAN), wireless personal area network (PAN), a 3G, 4G or other generation cellular or wireless communications network, a satellite network and other types of networks. When used in a LAN networking environment, computers may be connected to the LAN through a network interface or adapter.

When used in a WAN networking environment, computers typically include a modem or other communication mechanism. Modems may be internal or external, and may be connected to the system bus via the customer-input interface, or other appropriate mechanism. Computers may be connected over the Internet, an Intranet, Extranet, Ethernet, or any other system that provides communications.

Some suitable communications protocols may include TCP/IP, UDP, or OSI for example. For wireless communications, communications protocols may include Bluetooth, Zigbee, IrDa or other suitable protocol. Furthermore, components of the system may communicate through a combination of wired or wireless paths. For some aspects, such as for the transfer of payments, the communications infrastructure may include networked systems such as the Electronic Funds Transfer (EFT) network, trade exchanges, Electronic Data Interchange (EDI), Extensible Markup Language (XML), and other secure and/or non-secure communication channels and languages known in the industry for implementing trading transactions (which may include settlement operations) and payment systems such that those described herein.

Although many other internal components of the computer are not shown, those of ordinary skill in the art will appreciate that such components and the interconnections are well known. Accordingly, additional details concerning the internal construction of the computer need not be disclosed in connection with the present components and interconnections.

According to various aspects or embodiments of the present disclosure, any of the various abovementioned computer-oriented systems may be used or applied to the collection, processing, formatting, presentation, or other use or dissemination, of data or information. Further, aspects and embodiments of the present disclosure may utilize any of the above mentioned computer-oriented technology in performing or accomplishing any of the above or below mentioned processes or methods.

For purposes of various exemplary applications of the foregoing systems and methods, exemplary embodiments are described below. These descriptions are not intended to be limited to the following settings, but may be realized in conjunction with various types of systems, as understood by those possessing ordinary skill in the art.

One with skill in the art will realize that the present systems and methods may be utilized in any situation where a shopper desires to purchase or is considering purchasing more than one item at the same time or at different times in the same transaction or related series of transactions. These items may be related in some way or may be unrelated. Non-limiting examples of related items include: decorating or furnishing a room, monthly replenishment of office supplies, home building or remodeling, buying ski clothes and equipment, a home entertainment system, periodic replenishment of school supplies, outfitting a dorm room, preparing for summer camp, rebuilding a vintage car, renovating a kitchen, or starting up a business. As a non-limited example of unrelated items, a department store web site could offer different discounts depending on the types, quantities, and order value of goods purchased or a blogger could present a list of best new products. Other non-limited examples of unrelated items include shopping for multiple items on a single Internet site, such as books, CDs, DVDs and apparel. Other non-limiting examples will become clear based on the present disclosure.

As used herein, the following terms have at least the following, non-limiting respective meanings, whether or not capitalized:

“Bundle” means a bundle, collection or aggregation of goods or services or both, to be offered, purchased, sold, created or modified in one or a series of transactions.

“Bundle Systems” means the systems used by vendors to facilitate the creation and modification of bundles, as more particularly described herein.

“Element” means the elements or components that customers can use individually or in combination with other elements and PURLs, including in bundle systems and as selectively combined by a vendor, as more particularly described and defined below.

“Customer” means a customer, purchaser or prospective purchaser of any goods or services or both, including retail or wholesale customer and whether customer is a consumer or business.

“Interfaces” refer to the customer interaction component of the system, which enables the customers to interact with the bundling system, including interacting with the systems regarding goods or services offered by vendors to offer, purchase, create or modify bundles, including (but not limited to) the following: a web site, social network, tweet, text message, voice communication or other electronic display of text or graphics on a device.

“PURL” means a pop up recommendation list.

“Sponsor” means a retailer, wholesaler, “expert,” blogger or salesperson or other vendor sponsoring a PURL.

“Vendor” means any individual or entity that benefits from the sale of products or services or both, including without limitation a retailer, distributor, wholesaler, manufacturer, “expert,” sponsor, blogger or salesperson.

### Bundle Systems

The following are examples of bundle systems and are presented herein solely for descriptive benefits, and are in no way intended to limit the scope of the present disclosure.

In on embodiment, a bundle system typically includes a plurality of elements: a customer interface, a fulfillment module, administrative module, payment module, and a pricing or comparison engine. However, in other embodiments, a bundle system may include as few as one element, or may include additional elements such as an administrative module and a payment and transaction module. As will be understood by those of ordinary skill in the art, any number of modules, or a single module, may be used with existing systems or third-party systems.

The customer interface 205 provides various ways in which (i) the system of a vendor or sponsor can present a bundle to a customer with a price on a real time basis or (ii) the customer can request the bundle from the system of the vendor or sponsor, which in turn automatically and almost instantaneously provides a price and in some cases, suggested items for the bundle. In vendor-created bundles, the vendor uses an administrative control panel, tied into the pricing engine, to create various bundles (of goods and/or services) to meet its objectives. The vendor displays those bundles through one or more interfaces. In customer-created or changed bundles, a customer creates a bundle from vendor's catalog or changes a bundle created by the vendor. The pricing engine almost instantaneously generates a price for the customer created or changed bundle. At the vendor's option, the system can provide guidance as to changes tried by the customer and other suggested products or services. The suggestions are generated by the pricing engine and manifested in the applicable interface.

The fulfillment module 241 enables fulfillment by the vendors and sponsors of the orders for bundles, discussed in part ii below, through automated electronic communications.

The pricing engine and/or comparison engine 203 (discussed below) provides the vendor or sponsor with visibility into the economic attributes of various individual items and bundles including various combinations of individual items (including competitiveness with items and bundles with market prices). The pricing engine determines the aggregate price of items purchased together in a particular bundle, both in vendor-determined bundles and on a real-time basis for bundles created or modified by customers. The comparison engine, which includes a pricing engine, compares the vendor's own bundles and/or the bundles of other vendors to determine what bundles and respective prices to offer the customer. The vendor uses a control panel 201, tied into the pricing engine and/or comparison engine, to set the business rules that the pricing engine and/or comparison engine applies, on a real-time basis and without the necessity of further vendor action, to create, compare and price various bundles of goods or services in light of vendor's business objectives and other alternatives available in the market place.

The administration module 201 facilitates a vendor's log-in to the control panel to manage the structure of bundles and set the objectives to be achieved in formulating and pricing the bundles. These objectives may be used in the pricing engine to set bundle pricing.

The payment and transaction processing module 207 may be provided by various third-parties and enables the processing of payment and transaction information such as credit card information, shipping information, billing information, allocation of payment between vendors, etc.

In this way, through the combination of various elements, a number of bundle systems can be created, including but not limited to the following. A dynamic bundle system, comprising: vendor-created bundles and/or customer-created or modified bundles, fulfillment from vendor's catalog, administration module, shopping and transaction module, and pricing engine. A concierge bundle system, comprising: customer-created bundles; fulfillment through vendor's catalog, whole concierge bundles fulfilled by multiple parties, and partial concierge bundles fulfilled by multiple parties; and pricing engine and/or comparison engine. Pop up recommendation list, comprising: pop up recommendation list (PURL); fulfillment through vendor's catalog, whole concierge bundles fulfilled by multiple parties, and partial concierge bundles fulfilled by multiple parties; and pricing engine and/or comparison engine.

### Dynamic Bundle Systems

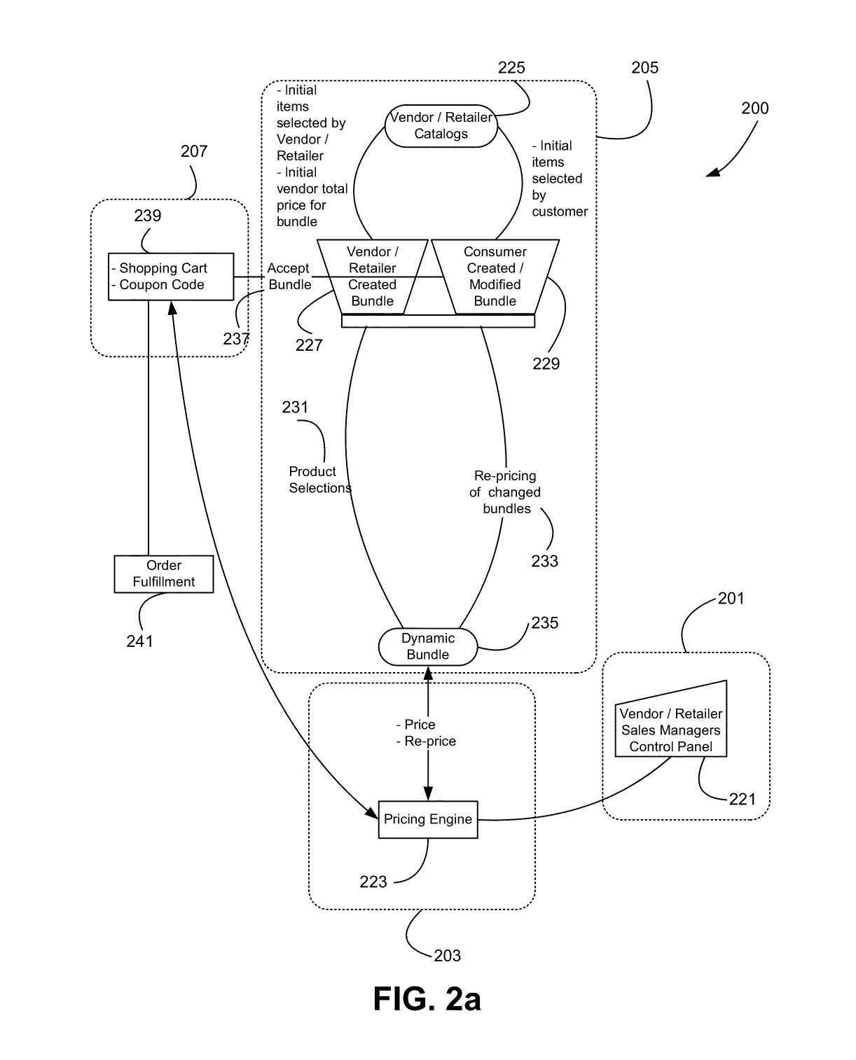

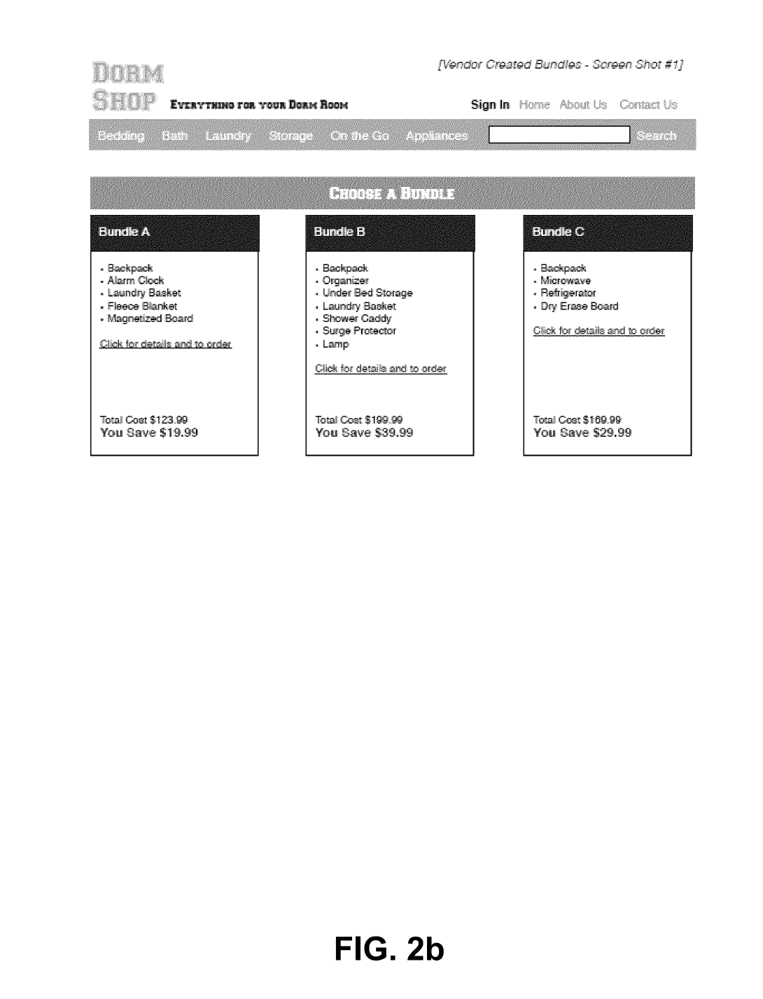

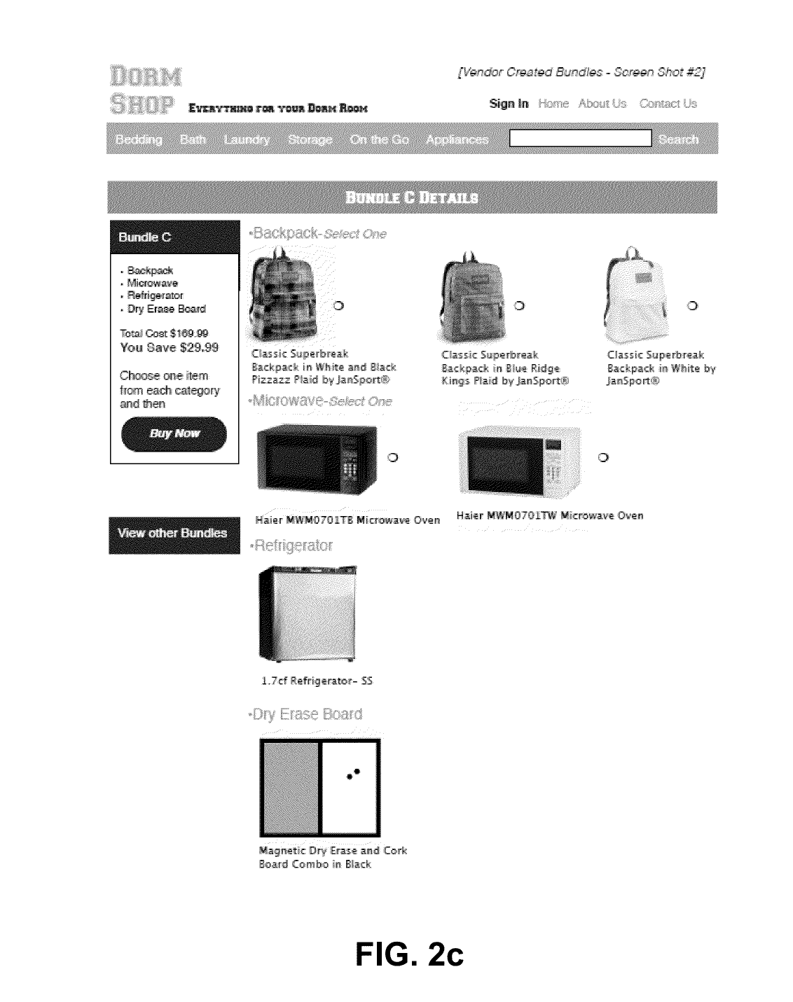

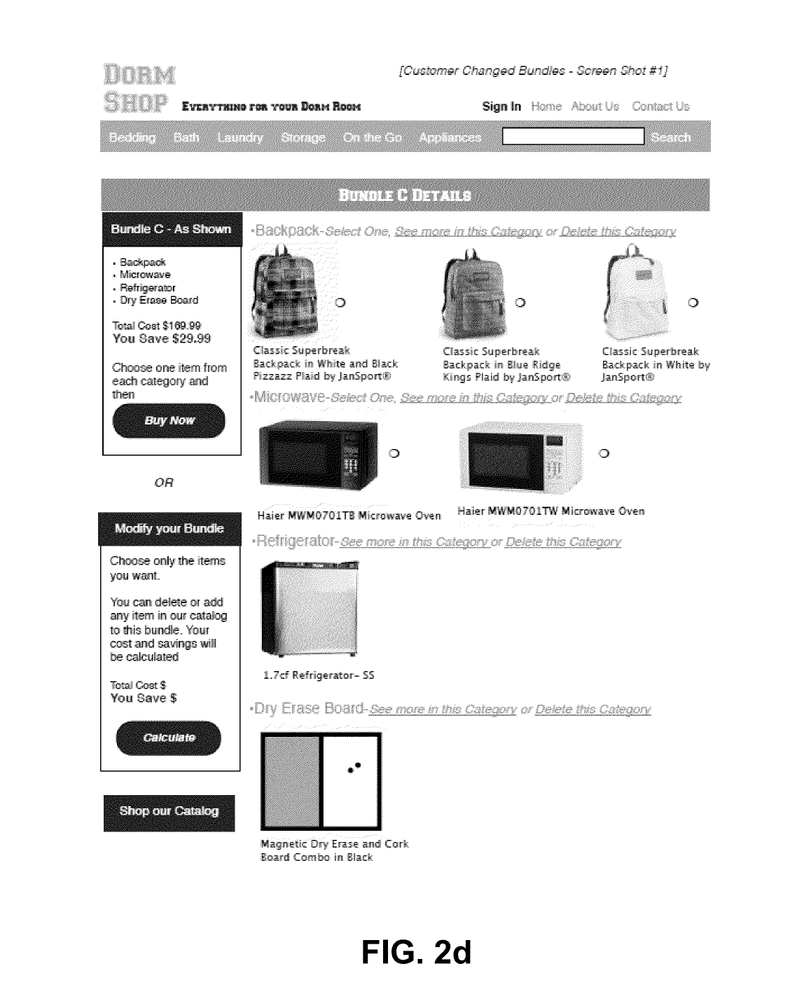

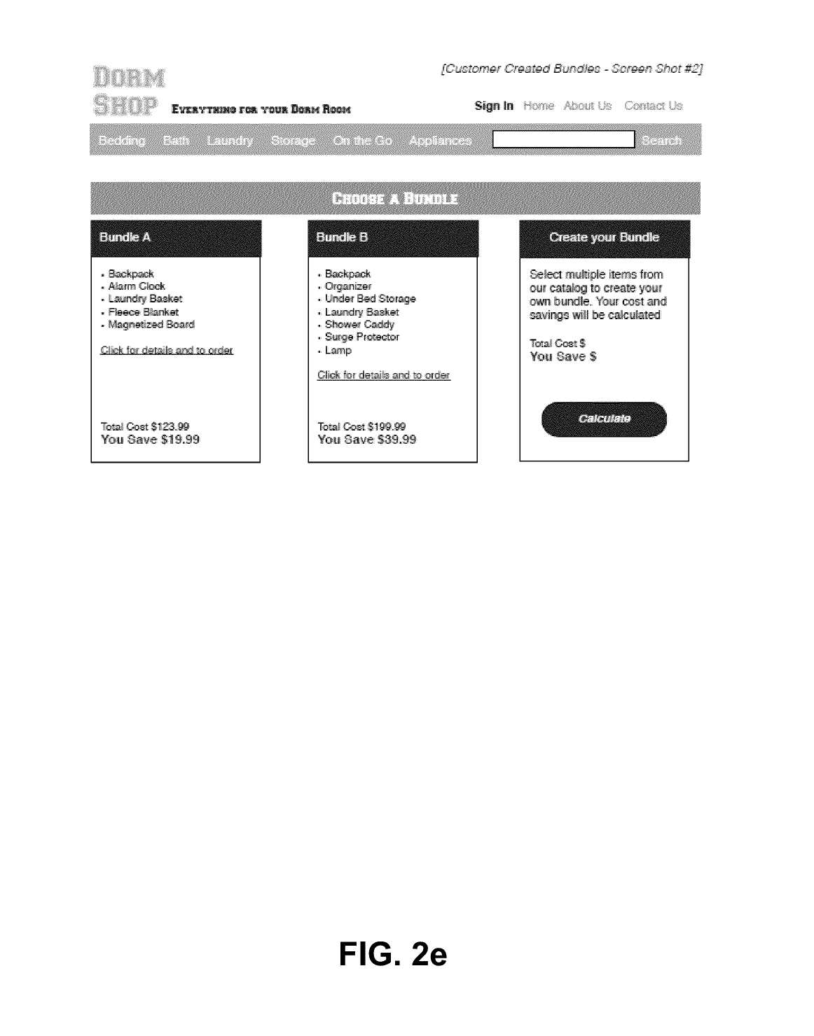

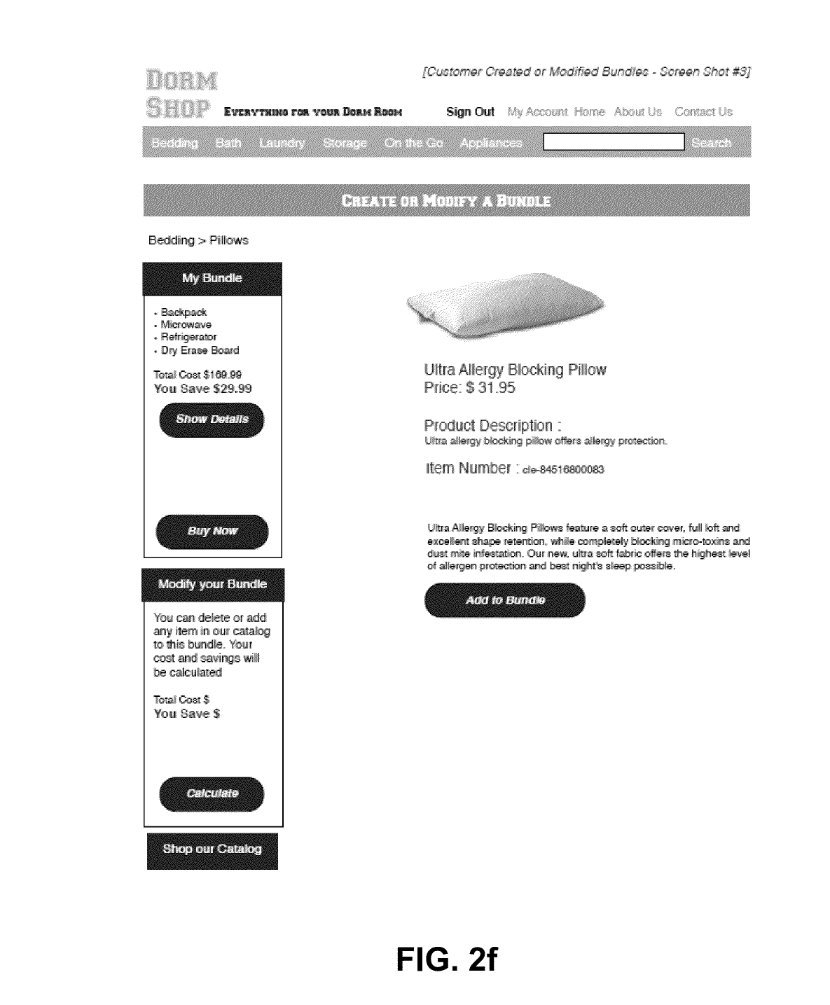

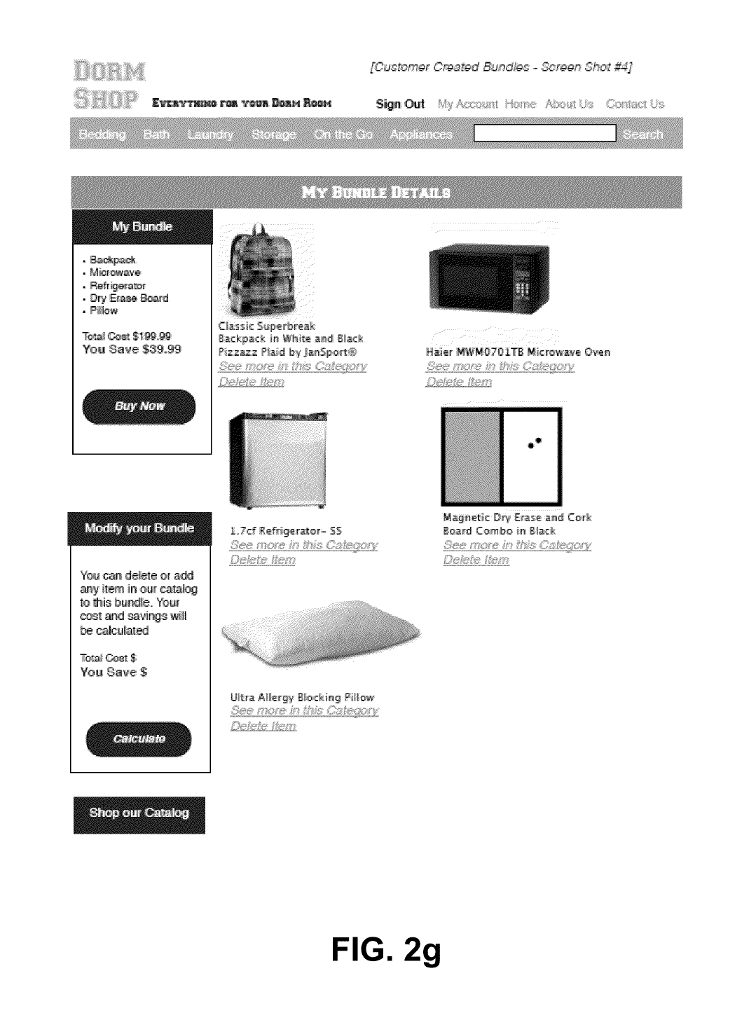

FIG. 2a shows a high level workflow diagram of a dynamic bundle system 205 that includes both vendor-created bundles and customer-created and modified bundles. In one embodiment of a dynamic bundle system 205, a vendor can pre-determine one or more bundles for multiple goods and/or services priced based on the vendor's business objectives and in light of market conditions, and on a real-time basis customers can vary bundles supplied by vendors or create their own bundles. In some (but not necessarily all) cases the bundle may enable the customer to receive discounts over the sum of the individual prices of items in the bundle.

FIGS. 2b-2d illustrate screen shots of an exemplary web site named, in this example, “Dorm Shop,” which enable the purchase of bundled dorm room related items. In this embodiment, the bundles may include a plurality of goods and/or services preselected by the vendor.

The processes of FIG. 2 are complemented by additional modules. For example, an administration module 201 enables a vendor to log in to the control panel from time to time to manage the structure of bundles and set the objectives to be achieved in formulating and pricing the bundles through the vendor control panel 221. Additionally, a shopping and transaction module 207 enables the customer to purchase the bundled products through the shopping cart 239, which may include the ability to enter coupon codes in one embodiment. A pricing engine module 203 may also be included that is configured to determine the price for each bundle based on algorithms and objectives selected by the vendor through pricing engine 223 optionally taking into account market prices for the items in the bundle. The foregoing modules in the dynamic bundle system 200, whether offering vendor-created bundles or customer-created or modified bundles, or both, are referred to collectively as a “dynamic bundle system.” The dynamic bundle system 200 may be automated to perform pricing and presentment almost immediately (e.g., on a real-time basis) after the customer submits to the vendor a modification of a bundle or a proposed bundle. In one embodiment, aside from setting the pre-determined rules, no human action on the vendor side may be required to price a customer-modified or varied bundle during the transaction; however, in another embodiment, human action on the vendor side may be required or enabled to price a customer-modified or varied bundle during the transaction. In one embodiment, as a bundle is modified, the bundling system can provide guidance as to how the total price (or individual prices) may change as the bundle is modified by the user, such as through suggested items that would be in the same price range.

In the process of elements in block 205, the customer is able to select from vendor-created bundles 227 that are based on generally available web based vendor catalogs 225 where the initial bundle is presented with product descriptions and/or total price for the bundle. For example, a vendor could provide several bundles, each containing items for a skier (e.g., skis, goggles, poles, ski attire, etc.) For a set price that reflects a discount from the prices of the individual items.

In one embodiment, the customer may be presented with product information contained in vendor catalogs 225. The customer may create a bundle based on his or her own specific choices, which is referred to as a “customer created/modified bundle” 229. In the present example, in choosing from the vendor's wide range of dorm-related products in the vendor's catalog, the customer may elect to bundle only under bed storage and an alarm clock rather than a more complete bundle including a refrigerator and a microwave, for example. FIGS. 2e and 2f illustrate screen shots showing an interface of customer created/modified bundle 229. The vendor-created bundles 227 may be processed through the dynamic bundle system 235 to change or modify the original bundles to the customer created/modified bundle 229.

Customers may modify the contents of the vendor-created bundles 227 to suit their needs. In one embodiment, such as the present example, the customer could accept the bundle with certain changes (for example, changing the brand of alarm clock). This change could result in a change in the price of the bundle. At the vendor's option, the system can provide guidance to the vendor as to changes tried or considered by the customer and make suggestions as to other products or services. The suggestions are generated automatically by the pricing engine 223 and manifested in the applicable interface. For example, the system could alert the customer to the fact that the substitution of a particular alarm clock for the one previously in a bundle would cause the bundle price to increase and suggest another alarm clock or alarm clocks that would be comparable and have less of an adverse effect on price.

Prices of each bundle (whether created by the vendor or created or modified by the customer) may vary based on who the customer is (e.g., group membership) and where the customer lives, for example.

Vendor-created bundles 227 may be pre-configured by the vendor based on their objectives in respect of margins per item, per order, or per customer, sales volumes (e.g., as to particular transactions, goods, customers or overall volumes), order size, competitiveness with prices in the marketplace, and/or inventory reduction using the vendor control panel 221, the vendor catalog 225 and algorithms designed to achieve various alternative business objectives (i.e., pricing engine 223). For example, to move obsolete or dated inventory, the vendor might price a complete dorm room bundle with last year's model of microwave less than a comparable bundle with this year's model of microwave. Bundles may be presented as a single entity with a single price. In one embodiment, at the vendor's option, the prices of the individual items in the bundle may or may not be shown. Not showing the prices would focus the customer on the overall price and aggregate savings, rather than on the prices and savings of individual items.

Customers may modify the contents of the bundle to suit their needs but the bundle pricing may be re-priced automatically and on a real-time basis with each change to the bundle. Changes may include the addition or subtraction of particular items and changes in the quantity of items. The revised product selections 231 are submitted to a dynamic bundle system 235 to be configured automatically before being submitted to the pricing engine 223. The formatted selection information is used by the pricing engine 223 to determine the price of the bundle and the priced or re-priced bundle may be presented to the customer 233, all on a real-time basis.

Customers may create their own customer created/modified bundle 229 from the vendor catalog 225 and thereafter modify those bundles 229. The customer created/modified bundle 229 may reflect the items that the customer would like to purchase as a group, whether the items are related to an objective or not. Customers may select more than one item from the catalog, such items comprising a “bundle,” and can submit each bundle for pricing by the pricing engine 223. Product selections 231 associated with customer's initial selections or revised bundle automatically may be assembled or re-assembled respectively and formatted into the dynamic bundle 235. Product selection elements to be used by the pricing engine 223 may include, for example, vendor, sku, UPC, item number, category, price, quantity or multi-vendor discounts, as well as other product specific information. The formatted selection information is used by the pricing engine 223 to determine the price of the bundle and each priced or re-priced bundle may be presented to the customer 233 immediately after the customer submits the modified or customer-created bundle for pricing.

In one embodiment, the pricing engine 223 automatically determines the price of each bundle using pricing rules algorithms and based on vendor's choices and, optionally, prices in the marketplace for goods comprising the bundle which may evaluate the strength of the bundle from a pricing perspective and which may further compare the overall bundle to various baskets of goods automatically as the bundle is created. As discussed below, vendor can use the control panel of the administration module (if available in that particular bundle system) to optimize the composition of bundles, whether created by vendor or created or modified by customers, based on the vendor's objectives.

At various points throughout the shopping process, the customer can accept the bundle of goods at the current price 237, or the customer can again change the bundle and re-submit the changes as exemplified in customer created/modified bundle 229.

Once the bundle is accepted by the customer, goods may be purchased using a shopping cart 239, where the total price (based on the items in the bundle and, optionally, after giving effect to any discounts or coupons) reflects the pricing generated by algorithms of the pricing engine 223. In one embodiment, the aggregate price presented to the customer reflects the discounts from bundled pricing. In one embodiment, a total price is presented based on “list prices” and optionally showing a “bundle discount” to arrive at a lower bundled price. In one embodiment, the price (whether or not reduced from list prices) may be reduced by a discount or a coupon code that has been generated to reflect additional discounts based on the rules defined by the vendor. These additional discounts may be indicative of the particular customer's characteristics (such as loyalty programs or previous purchases), a group to which the customer belongs, or a referring website, social media location or other location from which the customer came.

Completed orders may be transferred (electronically or manually) from the shopping cart to order fulfillment 241 for the vendor(s) to pick and ship the selected items to the customer.

The pricing engine 223 is the center of the process that applies the objectives of the vendors to the bundle of goods submitted by the customer via the dynamic bundle process 235. Vendors may use the control panel 221 to set their objectives. The pricing engine 223 is configured to determine the price of each bundle automatically, using pricing rules algorithms based at least in part on the vendor's objectives. See Section IV:A below for a further description of the pricing engine element and the algorithms.

The administration module 201 refers to a group of tools that vendors may use to manage the structure of bundles, model the profitability of bundles, and determine the availability of bundles. See Section III below for a further description of the vendors/retailer sales managers control panel 221 and other elements of the administration module 201.

### Concierge Bundle Systems

In the concierge bundle systems, a customer may provide a list of specific items (by product name, serial number, stock-keeping unit (sku) or other identifier) for creating a bundle. Optionally, the system could permit the customer to specify a price or a maximum price for some or all of the specific items. For example, the customer may tell the concierge bundle system that “I will buy this list of particular home entertainment components for $1,500.” Where the vendor sources some or all of the items from third-party suppliers, the vendor may use the comparison engine 303, discussed below, to evaluate bids from suppliers. The proposed bundle characteristics or specifications may be distributed electronically to bidders, who may electronically and almost instantaneously submit proposals in response to the proposed bundle.

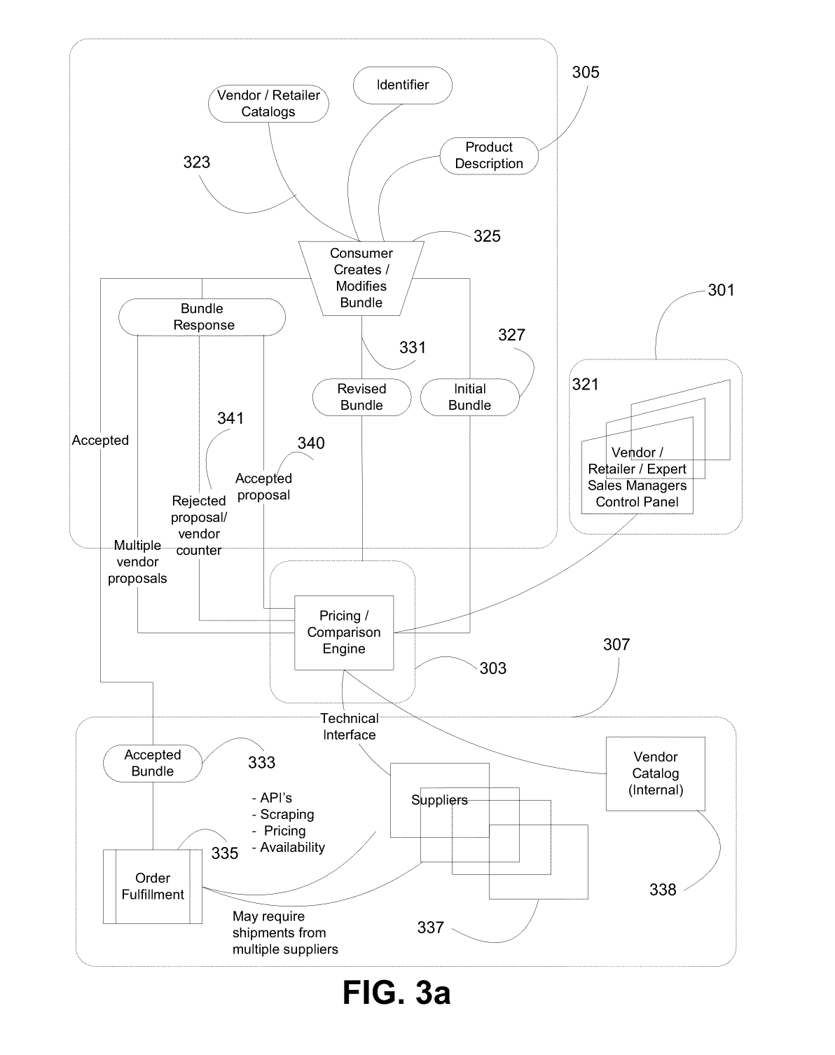

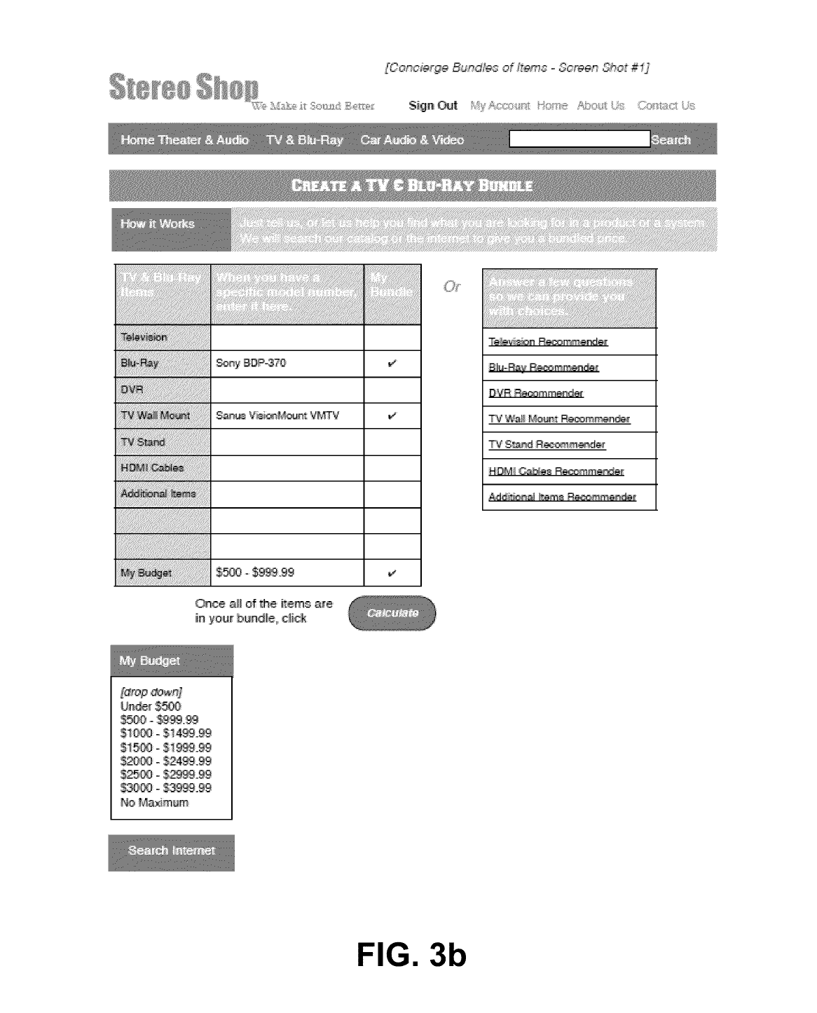

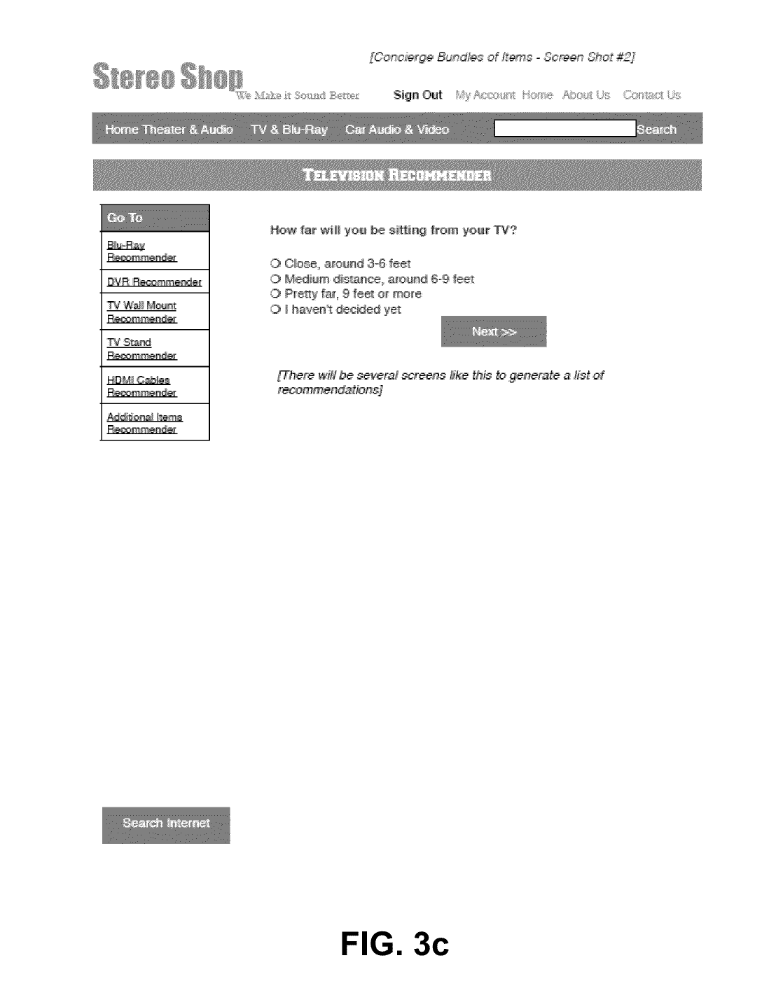

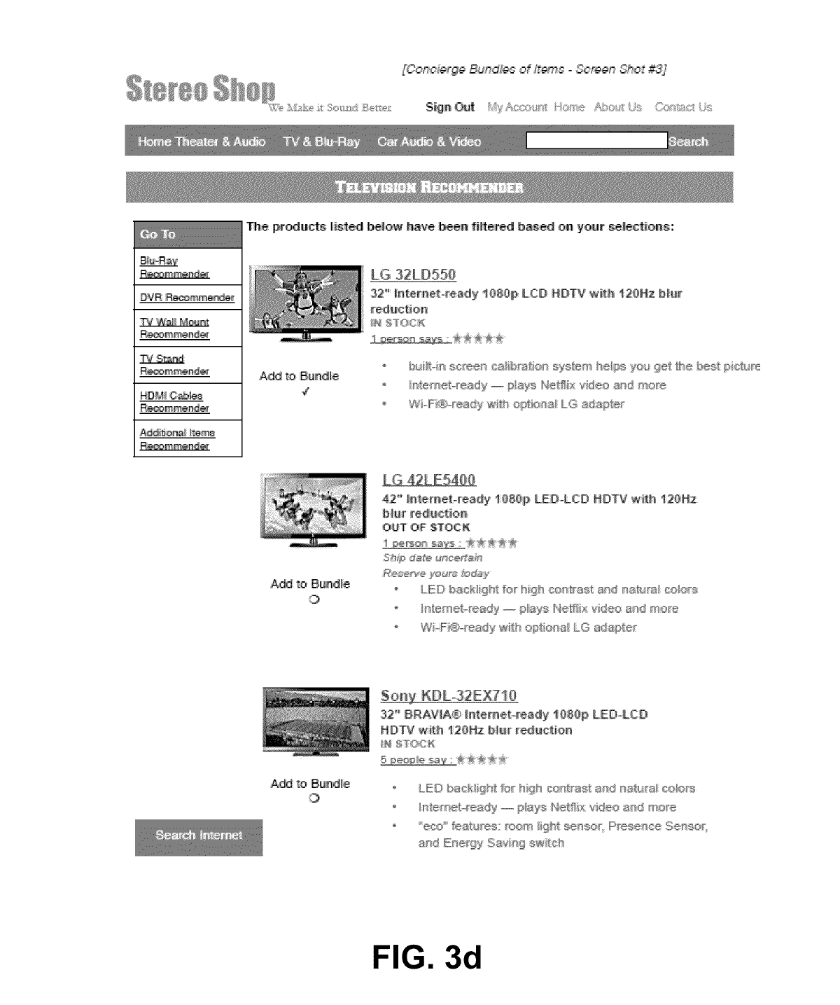

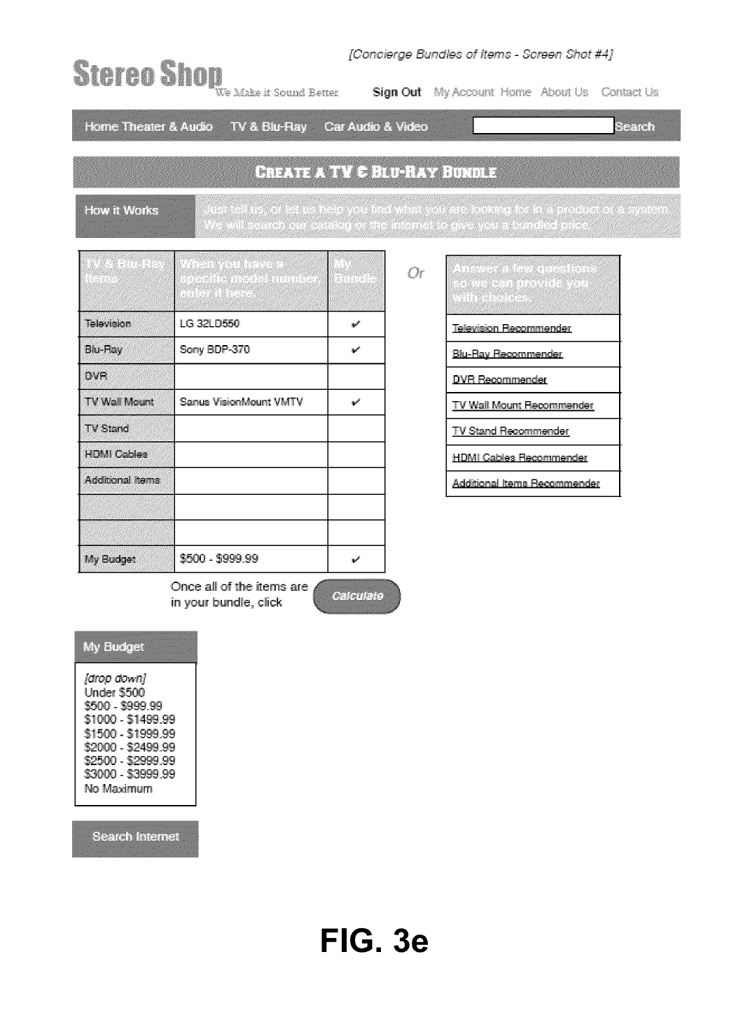

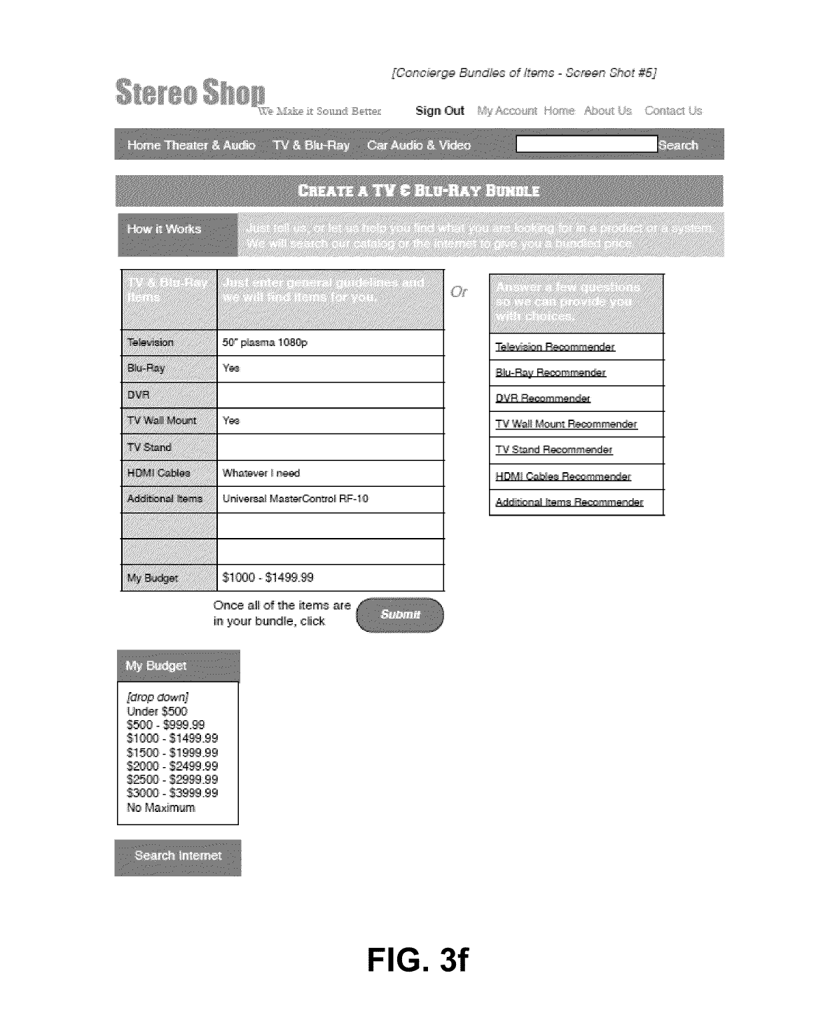

FIG. 3a shows a high level workflow diagram of a concierge bundle system 305. In one embodiment, the concierge bundle system 305 enables a customer to submit a list of multiple goods, or alternatively a set of characteristics or specifications for multiple goods, to a vendor, for proposed fulfillment and/or pricing. FIGS. 3b-3d illustrate a number of screen shots showing a concierge bundling process that is executed, according to this example, through a vendor having a web site named “Stereo Shop.” The system, using vendor's pre-determined rules, may fulfill a customer's request with items from the vendor's own catalog, or alternatively from third-parties (bidding as to some or the entire bundle such as through a reverse auction), or a combination thereof. In one embodiment, these processes may be complemented by an administration module 301 whereby a vendor is able to log in to the control panel 321 of the administration module 301 to manage the structure of bundles and set the objectives of the vendor to be achieved in formulating and pricing the bundles and may further be accompanied by a shopping and transaction module 307 for facilitating the customer purchase of the bundled products. As discussed below, the system can include a pricing engine module 303 that is configured to determine the price for each bundle supplied by the vendor automatically based on algorithms and objectives selected by the vendor. If the system enables fulfillment of some or all of the concierge bundles requested by customers using one or more third-party suppliers, the system may include a comparison engine 303. The foregoing modules comprise the system referred to as the “concierge bundle system” 305. The concierge bundle system 305 may be automated to perform pricing and presentment almost immediately (i.e., in near-real-time) after the customer submits to the vendor a proposed bundle (whether for specific items or using specifications) or changes to a proposed bundle. Aside from setting the pre-determined rules, no vendor action is required to price a concierge bundle.

The system may be a closed system, where potential bidders may be required to enter the system through a secure portal, for example, by entering a user name and/or password. Alternatively, the system may be an open system where on a publically available page, the customer enters search terms for the items (such as specific items comprising a bundle or can provide specifications or characteristics) and anyone can bid on the bundle. In this configuration, the vendor or system may rate the bids and present the best bidder (by price or otherwise) on the vendor or search page (meaning that bidders can pay to have their bids appear in a higher visibility or priority area). Orders are fulfilled without an electronic store and may be filled between the winning bidder and the customer.

Customers may be able to order a bundle of goods 325 that a vendor's system would fulfill automatically, or alternatively manually, from either its own catalog or from catalogs of third-parties (in whole or in part) or both. The vendor's system essentially acts as a “concierge” to locate the products and evaluate the customer entered price, maximum price, or price range (if any) for the bundle and optionally communicate whether achievement of such price is unrealistic. The interface is configured to enable the customer to select from existing indexed searchable vendor catalogs 323, product identifiers (i.e., sku, ISBN, UPC, etc.) Or product description information. Product information may come from pre-loaded catalogs, the website or third-party websites, or a combination.

In a concierge bundle, the customer provides a list of specific items (by product name, product type, product model, model or serial number, sku, UPC or other identifier) for the bundle. In one embodiment, the system may provide features to assist the customer or prompt the customer. Optionally, the system may permit the customer to specify a price or a maximum price for the specific items. (e.g., “I would like to buy this list of particular home entertainment components for $1,500.”) Optionally, the system may enable a customer to make a binding offer to buy a specified list of items for a specified price. Where the vendor sources some or all of the items from third-party suppliers, the system is configured to use the comparison engine 303 to evaluate bids from suppliers on a real-time basis. See Section I:C below for a further description of the concierge bundles element.

In one embodiment of the present disclosure for a concierge bundle from specifications, the customer provides the system with a list of specifications, characteristics, and/or attributes (rather than the names of specific products) for various items that would comprise a bundle. For example, a customer desiring a home entertainment system could request proposals for the following: “60 inch plasma, 5 channel surround sound, a digital receiver with at least 75 watts, etc. For a 20×30 room.” FIGS. 3e and 3f illustrate screen shots of an interface enabling the customer to enter the specifications of this home entertainment system. The concierge system sources items from its catalog or third-parties or a combination and sources and provides one or more bundles that satisfy the customer's specifications. Optionally, the system could permit the customer to specify a price or a maximum price for bundles that conform to the stated specifications or attributes. (e.g., “I will buy a home entertainment system meeting these specifications for $1,500.”) Where the system sources some or all of the items from third-party suppliers, the comparison engine 303 evaluates and compares bids from suppliers and selects proposed bundles to propose to the customer, all on a real-time basis. See Section I:D below for a further description of the concierge bundles from specifications element.

In the case of either a concierge bundle or concierge bundle from specifications as described herein, product information for the initial bundle 327 may be formatted to be evaluated by the pricing engine 303 and/or comparison engine 303. Product information may come from multiple electronic sources and may be formatted to be displayed to the customer.

If the vendor fulfills the order from its own catalog only, the pricing engine 303 is configured to evaluate the customer's proposed bundle in terms of vendor preferences, margins, prices, availability, competitiveness with market prices, and engagement rules, etc. Acceptance rules that are entered by the vendor control the pricing engine's 303 response. In one embodiment, the pricing engine 303 is configured to automatically and on a real-time basis generate a response to the customer that the proposed bundle/price was a) accepted by the vendor(s) 340, b) rejected by the vendor with a counter proposal 341, or c) generated multiple vendor proposals 329, possibly with different prices and products.

The pricing engine 303 may need to obtain additional information from vendor's database, or alternatively from a third-party database, or from publically available information (such as through or from the internet) to provide sufficient information to create a bundled price, and may be tied into the databases and information. See Section IV:A below for a description of the pricing engine element.

More specifically, the system at vendor's option, could submit, electronically, the bundle or portions of the bundle to a plurality of suppliers 337 or other retailers, for bids with respect to all or some of the goods in the bundle. Some or all of the suppliers 337 may have pre-existing relationships with the vendor. In other cases the bids may be posted electronically on a website or location where interested bidders can be notified of proposed bundles and submit bids. Integrated vendors may be those that have data format mappings and commercial terms established in regards to costs and shipping charges. Non-integrated vendors are those whose products have been proposed for or included in the bundle but an electronic submission process or special pricing has not been established. Proposed bundle products or specifications, and bids in response thereto, may be communicated electronically, and on a real-time, almost instantaneous basis, except where the vendor otherwise elects.

With whole concierge bundles fulfilled by multiple parties, the concierge vendor's system can auction the bundles for bidding by third-party suppliers, each of whom can bid on the entire bundle. With partial concierge bundles fulfilled by multiple parties, various suppliers 337 (possibly including the vendor) may bid on the right to provide a portion or all of the items in the requested bundle. In some embodiments, the concierge vendor may be contributing some part of the bundle as well. (e.g., in the home entertainment system example, the vendor stocks only the requested digital receiver. The vendor wants to sell the receiver from its inventory but looks to third-party suppliers for the other components.) See Sections II:B1 and II:B2 for further descriptions of the whole concierge bundles fulfilled by multiple parties and partial concierge bundles fulfilled by multiple parties.

The comparison engine 303 is configured to evaluate and compare the pricing and proposed items from the vendor's own catalog and partial or complete bids from other bidders and assemble a price bid (and in the case of a bundle based on product descriptions or based on specific products where the vendor (or its suppliers) propose alternatives, changes to the bundle reflecting those products). If the bundle is for specific items, the comparison engine 303 may evaluate which of the bids is the best or preferable, usually based on price, but possibly taking into account other criteria, such as information about the supplier 337 (such as reliability), shipping information, availability, market prices, etc. If the bundle relates to specifications, the comparison engine 303 may use additional artificial intelligence to sort through bids and provide multiple alternatives for the customer to choose from. Again, the bid could be constrained by a specified price, maximum price, or price range determined by the customer. The comparison engine 303 may also enable the bundle system to go back to third-party suppliers in an iterative process to change the partial bundle as the vendor puts the optimal bundle together, optionally based on the vendor catalog 338. In one embodiment, this iterative process may occur automatically, electronically and on a real-time basis and yield outcomes that are either stated to a human representative of vendor or incorporated into the automated creation of suggested bundles that are passed directly to customer, but may occur in other ways as recognized by those having ordinary skill in the art. See Section IV:B below for a description of the comparison engine element.

The customer can evaluate the responses from the system, revise their bundle 325 and any price offer, price maximum, or price range, and re-submit for pricing and/or product mix 331. The customer can select and accept a bid response 333, which causes the accepted bundle to be entered into an order fulfillment process 335. The product, detailed pricing, and supplier reference number information may be structured for the order fulfillment process 335. In one embodiment, this structure may be dictated by or dependent upon a particular vendor.

The vendor(s) may fulfill the order 335. This process may electronically divide the orders amongst the suppliers 337 (if multiple suppliers are involved) and provide shipment and payment information to complete the transaction on a real-time basis.

The control panel 321 in the administration module 301 is configured to provide vendors with the mechanism to set the rules applicable to the pricing engine and comparison engine, evaluate bidders, direct the response to concierge bundle requests, manage the structure of bundles, model the profitability of bundles, and determine the availability of bundles. The control panel 321 offers a mechanism to divide orders among the suppliers based on a different rule set when an identical item is available from multiple sources. See Section III below for a further description of the control panel element 321 and other elements of the administration module 301. Pricing rule algorithms used in the pricing engine may be based on multiple criteria that reflect, for example, the vendor's objectives. See Section IV:A below for a further description of the pricing engine element.

### Pop Up Recommendation System

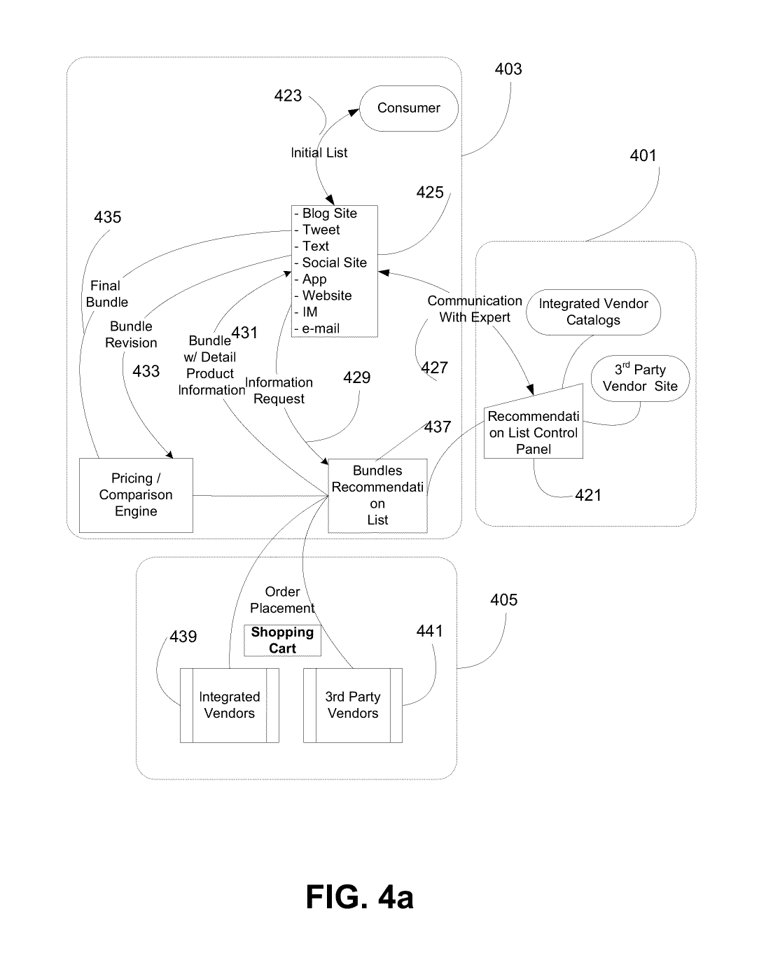

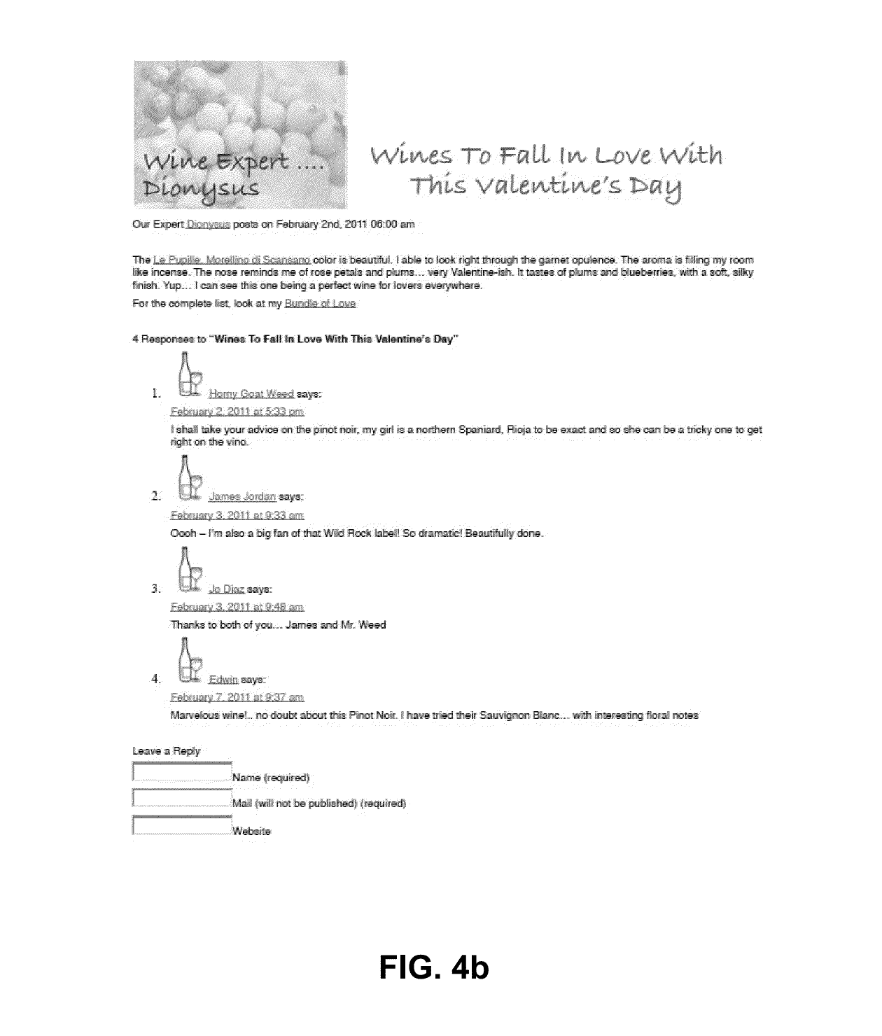

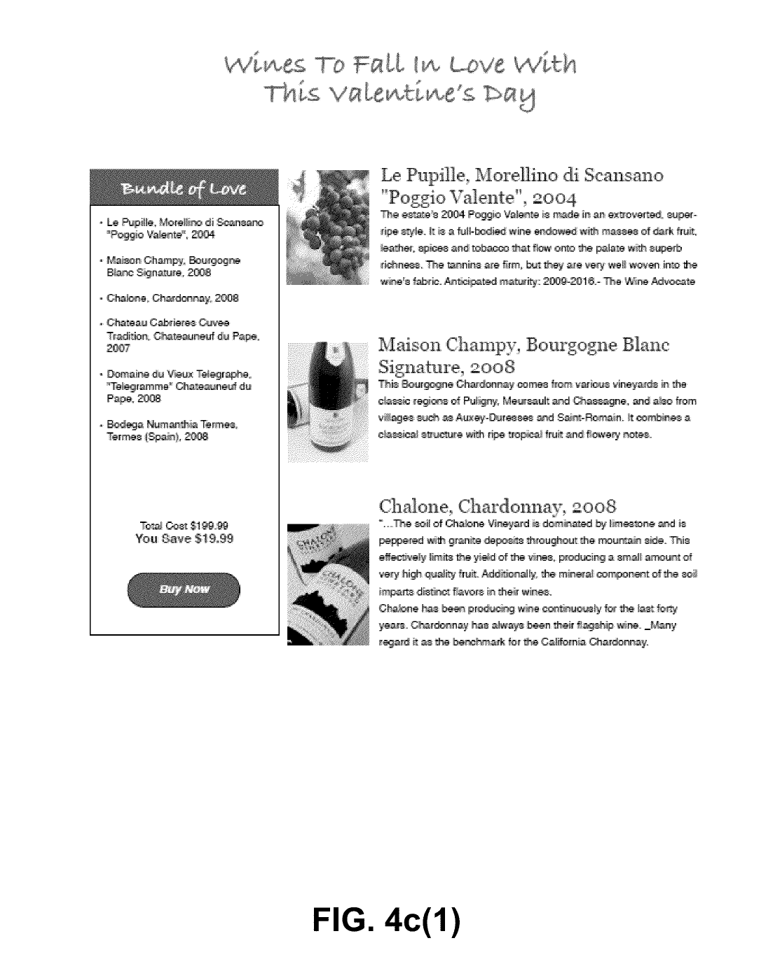

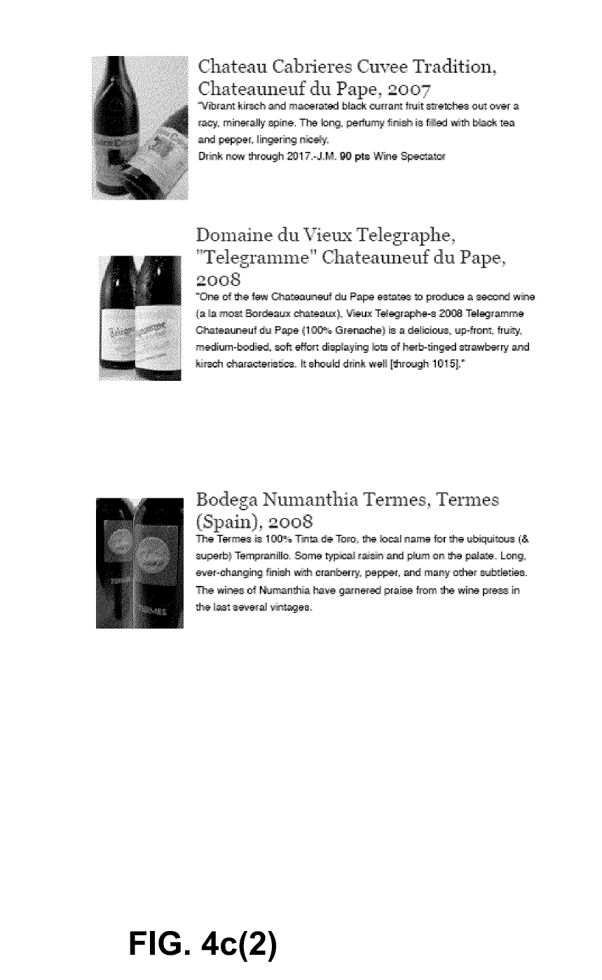

FIG. 4a shows a high level workflow diagram of the pop up recommendation (PURL) system 403. In one embodiment of the PURL system 403, a sponsor can create, in advance or on a real-time basis (either manually or using artificial intelligence) in response to communications with prospective customers, one or more PURLs, which are in essence bundles for multiple goods and/or services priced based on, for example, the sponsor's business objectives. Customer interactions with PURLs (after being created by a sponsor) may be automated and may occur on a real-time basis. In one embodiment, a PURL may appear as an icon on a third-party page, showing that a recommendation list is an actionable bundle available for the customer.

These processes are complemented by an administration module 401 whereby a sponsor is able to login to the control panel 421 to establish recommendations, choose products to include in one or more PURLs so that customers can buy the products and/or services in such PURL and create linkages to its own catalog or external sites, provide dynamic bundle functionality to facilitate the modification of PURLs by customers, including pricing and market comparisons using the pricing engine, and a transaction and payment module for order fulfillment and transaction and payment processing 405. The sponsor can also manually intervene to create changes to PURLs in response to interactions with customers, such as while blogging and commenting. The foregoing modules in the system are collectively referred to as the “PURL system” 403.

The PURL is a list of recommended products and services typically presented with product descriptions and, optionally, a total price for the bundle. For example, a sponsor, who is an expert in wines, could make a list of recommended wines for particular tastes or featuring particular regions or types of wines. FIGS. 4b and 4c illustrate screen shots of an interface for a wine expert sponsor. At the sponsor's option, the products and services included in the PURL could be priced, like other bundles, on an aggregate basis.

In this exemplary process, while using an external system such as a site for blogging (e.g., as shown in FIG. 4b), social network, e-commerce, texting, micro-blogging or other applications, the customer can take an action to access a PURL, which was created by the sponsor, such as by clicking on an icon or text, or requesting a recommendation. For example, in the screen shot of FIG. 4b, the customer may select the underlined text “bundle of love” to link to the PURL. A shown in FIG. 4c, the PURL is presented within the context of the site or application function and acts as a starting point to execute the PURL. This process initiates the request for bundle information and facilitate the subsequent modifications to the PURL, either by the customer in a manner similar to a customer-modified bundle or by the sponsor (either manually or using artificial intelligence) on a real time basis. Similarly, a sponsor can create and modify the PURL, optionally without having an electronic store. The artificial intelligence could sense the direction of a conversation between the customer and the sponsor (including as one of the bloggers, Tweeters, chat room participants, social networkers, commenters, etc.) and generate more responsive PURLs. For example, if the context is a blog focused on Cabernet wines, but the conversation turns to Malbecs, the PURL system could substitute or generate (based on pre-determined business rules) a new or different PURL.

Customer may view a PURL from a variety of external systems 425, and the initial list in 423 is merely exemplary and is not intended to be exclusive or limiting. The PURL may be initiated from the external system platform and a customer may view the recommendations on a different platform. For example, a customer might observe a recommendation list or a symbol indicating an underlying recommendation list as part of a blog entry or comment on a social network site. A PURL may be directed to a bundles recommendations list 437 given the contextual reference where product recommendations enhance the customer experience.

In one embodiment, the PURL may be created by a sponsor using the control panel 421 or by other elements of the PURL system 403 on a real time basis as described above.

The PURL may be available for a variety of platforms that take advantage of each platform's unique processing/data handling attributes and capabilities. But the information source and structure may be generated from a base structure (e.g., hosted product information) 421. In one embodiment, the PURL application on any platform may generally be a thin application that may be used as a starting point for the interaction. An icon or other symbol may represent the PURL on the platform.

An information request 429 may be sent by a prospective customer from the PURL application to initiate the session. The session may be initiated on the basis of a specific list name or code. The PURL process 437 is configured to take the initial request and return the stored PURL bundle 431 (i.e., the product list and, optionally, a single price) to the customer. In one embodiment, the PURL may interpret the product information (images, descriptions, price, expert comments, etc.) and display them on the end system. The foregoing may occur substantially automatically, on a real-time basis.

At the option of the sponsor, the customer may make changes to the PURL/bundle 437 that has been presented to them, using the customer-created or modified bundle element, as described more fully in Section I:B below. In the example of a home theatre system, a customer could change the digital receiver in the system for a less expensive model, submit that change to the sponsor by interacting with the PURL/bundle, and receive back a modified PURL/bundle and associated price. Like bundle revisions, PURL revisions 433 may be returned to the pricing engine to be re-priced based on the rules established by the sponsor. See Section IV:A below for a further description of the pricing engine element.

After a single review or multiple revisions, the customer can accept the items in the original or modified PURL as a bundle and submit a final acceptance 435 which transfers information 437 to the shopping cart to complete the transaction. Based on the source of the items in the PURL/bundle, transactions may be transmitted to integrated or third-party vendors. The PURL system 403 can be used with various fulfillment elements to facilitate partial or whole fulfillment by one or more third-parties.

In one embodiment, the shopping cart may be configured to be formatted for integrated vendors 439 or third-party vendors 441. Integrated vendors 439 may be those that have data format mappings and commercial terms established in regards to costs and shipping charges. Third-party vendors 441 may be those whose products have been included in the bundle but an electronic submission process or special pricing has not been established.

In this exemplary process the sponsor may have a suite of tools that manage the creation of PURLs (and associated bundles), publication of the PURL and interactive communication between the customer and sponsor familiar with the bundle and, at sponsor's option facilitate modification of the PURL/bundle and manual or artificial intervention in communications to modify or substitute PURLs.

The PURL control panel 421 is configured to provide the sponsor with the ability to manage multiple PURLs (create and publish), evaluate profitability and other economic attributes of each PURL/bundle (including as the PURL/bundle may be changed by the customer), communicate with the customer to provide expert information to support recommendations. See Section III below for a further description of the control panel element.

The sponsor may create a recommendations list 421 of goods and services that support a certain activity or level of use that a customer would find beneficial. The PURL incorporates certain expertise of the creator. For example, a camping expert would create multiple PURLs for beginning or intermediate campers as well as backpack lists for different climates. A PURL is itself educational, as it constitutes a list of recommendations, but also facilitates the convenient purchase of the goods and services in the PURL without leaving the location where the PURL is displayed.

As the recommendation lists are completed, the sponsor may publish each PURL that contains a linkage to the list name and an icon that can be used on an external site. The pricing engine element, bundles recommendation list 437, and/or recommended list control panel 421 may include a PURL/bundle assessment toolset that enables the sponsor to determine the profitability level of margins, competitiveness with other prices in the marketplace, success rates and factors and other economic attributes for each PURL/bundle. Items may be selected from integrated sponsor's catalogs using the pricing engine or one or more third-party vendor's sites using the fulfillment elements and the comparison engine, in a manner similar to the dynamic bundles and/or concierge bundles.

In one embodiment, a communications panel 425 may be available for the expert to interact with the customer. This interaction 427 enables the sponsor, as an expert, to answer questions or engage in a dialog about the bundle or activity where the bundle would be used, optionally responsive to an inquiry from the customer. Multiple methods of interactive communication 427 are anticipated ranging from web chat, instant message, text, phone or video conference, or other electronic communication. Customers may be able to initiate an interaction 427 with an expert/organization that created the PURL. In one embodiment, a separate application or site may be accessed to execute the communication. At the parties' option (and based on rules established by the sponsor), the communication may be visible to or hidden from others. Additionally and at the sponsor's option, these communications can facilitate modified or substituted PURLs.

### Search Bundle Functionality

One embodiment of the present disclosure may provide for a reverse auction for bundles of goods and/or services (bundles). In this embodiment, a customer may search 425 for a bundle the way that customers now search for individual items. In the search, the customer may describe and request bundles (by product name, serial number, ISDN, sku, UPC, or other identifiers, specifications, or characteristics) and may specify price parameters. The search may be made and the reverse auction effectuated anywhere and with any tool or app through, for example: search engines, web sites, shopping carts, mobile, blogs, social and physical, with or without an e-store. The system may interact with the customer 429 to better determine and describe the goods needed for the bundle.

Anyone can make a bid to supply some or all of a bundle request, including wholesalers, manufacturers and retailers (physical or virtual). The comparison engine may then evaluate the quality of each response, including as to its (i) responsiveness to the customer's criteria, (ii) value, (iii) quality, and (iv) price, and present the proposals. The comparison engine may assemble partial bids, and present the partial bids to the customer. Alternatively, the comparison engine may present partial bids without assembling them, leaving the customer to finish assembling the bundle, including through another bundle search. The system may additionally enable suppliers to make payments to promote their responses to the customer, similar to techniques used in pay search (e.g., SEO and ad-words).

In this way, a bid can be described with relatively little data: (i) universally recognized alphanumeric identifiers describing the products in a bundle, such as UPC codes, (ii) the price and link to order processing/payment, and (iii) a link to a manufacturer's catalog to access the product descriptions.

### Elements of Bundle Systems

### Section I—Customer Interfaces

The customer interface element is the interface between customers and vendors. There are several ways in which vendors (or sponsors or experts) interface with customers to create and/or modify bundles, and these can be combined in various combinations in bundle systems. Several non-limiting examples include:

Vendor-created bundles. The vendor uses an administrative control panel, tied into the pricing engine, to create various bundles (of goods and/or services) to meet its objectives and to assess the bundle from a market competitiveness perspective. The vendor displays those bundles through one or more customer interfaces.

Customer-created or changed bundles. On a real-time basis, customers create a bundle from vendor's catalog or change a bundle created by the vendor. The pricing engine generates a price for the custom or changed bundle automatically and returns the price to the customer almost instantaneously.

Concierge bundles. The customer provides a list of specific items (by product name, serial number, sku or other identifier) for the bundle. The system, using vendor's pre-determined rules, fulfills the request with items from vendor's own catalog, from third-parties or a combination thereof.

Concierge bundle from specifications. The customer provides the vendor with a list of specifications and/or attributes (rather than the name, serial number, sku, UPC, or other identifier of each specific product) for various items that would comprise a bundle. The list could include a combination of specific products for some items and attributes/specifications for others. Optionally, the system could permit the customer to specify a price, price range, or a maximum price for bundles that conform to the stated specifications or attributes. The system, using vendor's pre-determined rules, fulfills the request with items from vendor's own catalog, from third-parties or a combination thereof. Given that the customer may be open to different items, the system may return more than one concierge bundle for the customer's consideration.

Pop-up recommendation lists. The customer is presented with, and can access bundles by a click, a sponsor's pop up recommendation list (PURL) of product recommendations while using an external system such as a site for blogging, social network, e-commerce, texting, micro-blogging or application. The PURL is a bundle proposed by a sponsor, such as a vendor, blogger or “expert” (the “sponsor”), who would benefit, monetarily or otherwise, from the sale of some or all of the items in the PURL. Customer interactions to change the PURL, if permitted by its sponsor, are essentially the same as a customer-modified bundle. All customer interactions with PURLs (after created by a sponsor) may be automated and occur on a substantially real-time basis.

### Section I:A—Vendor-Created Bundles:

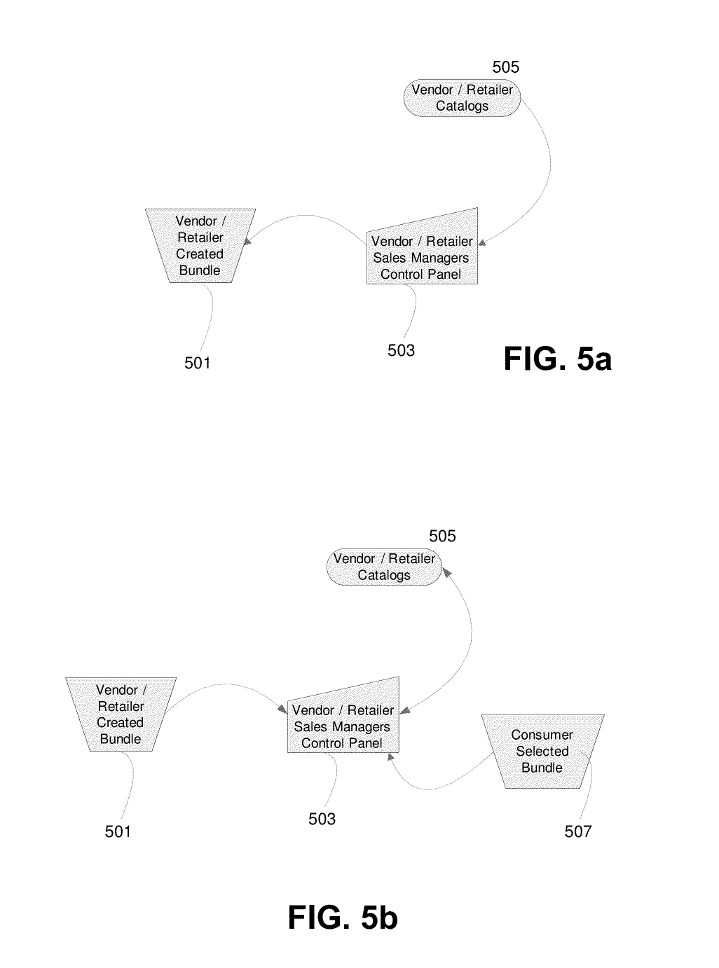

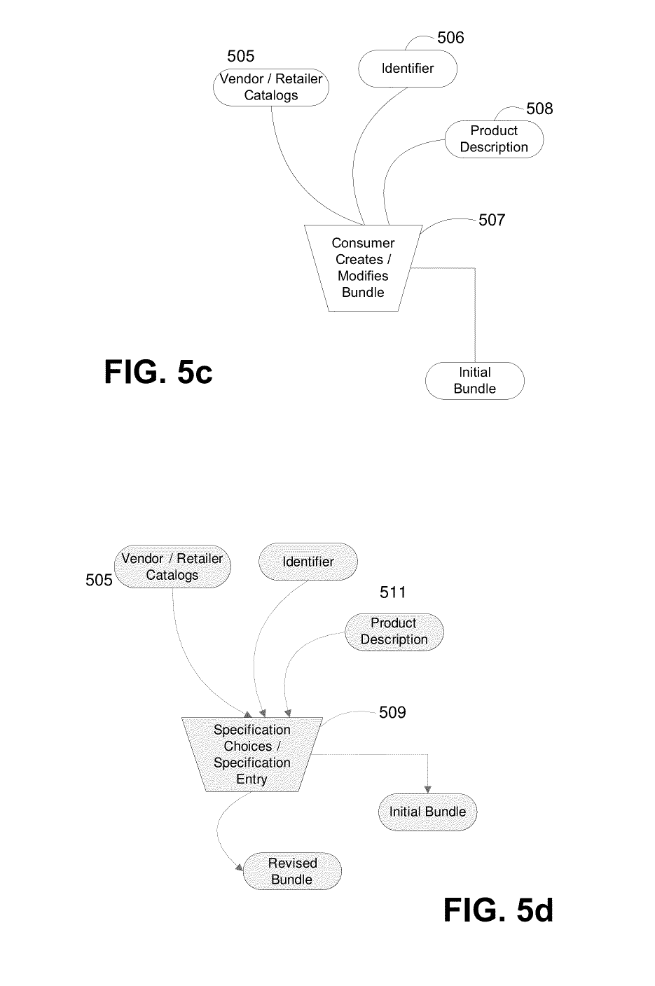

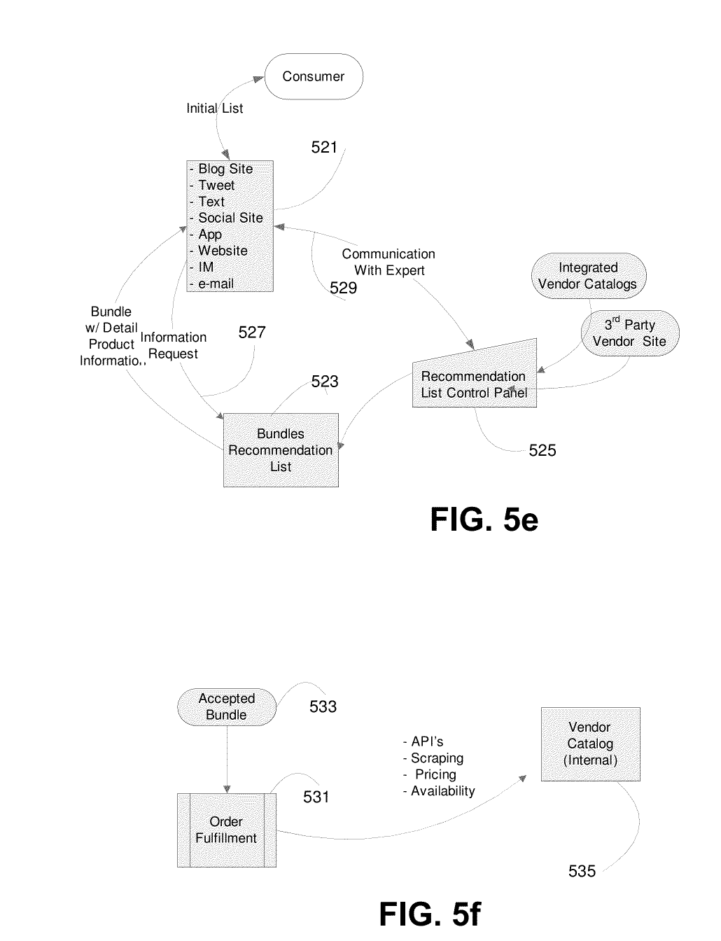

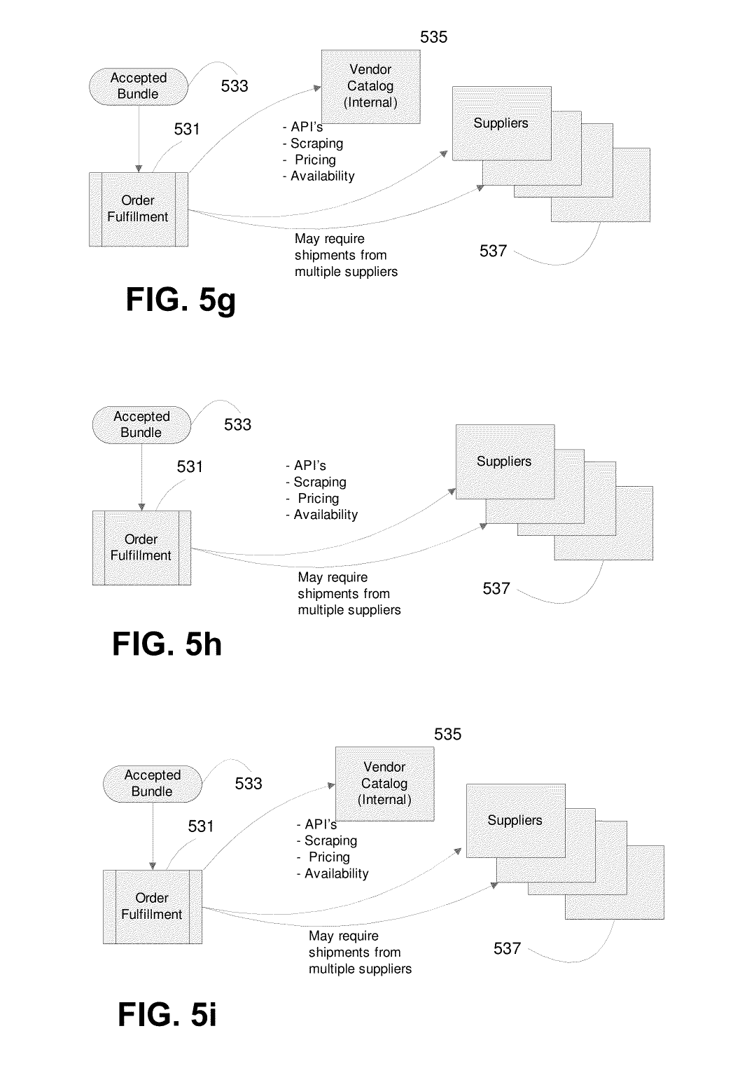

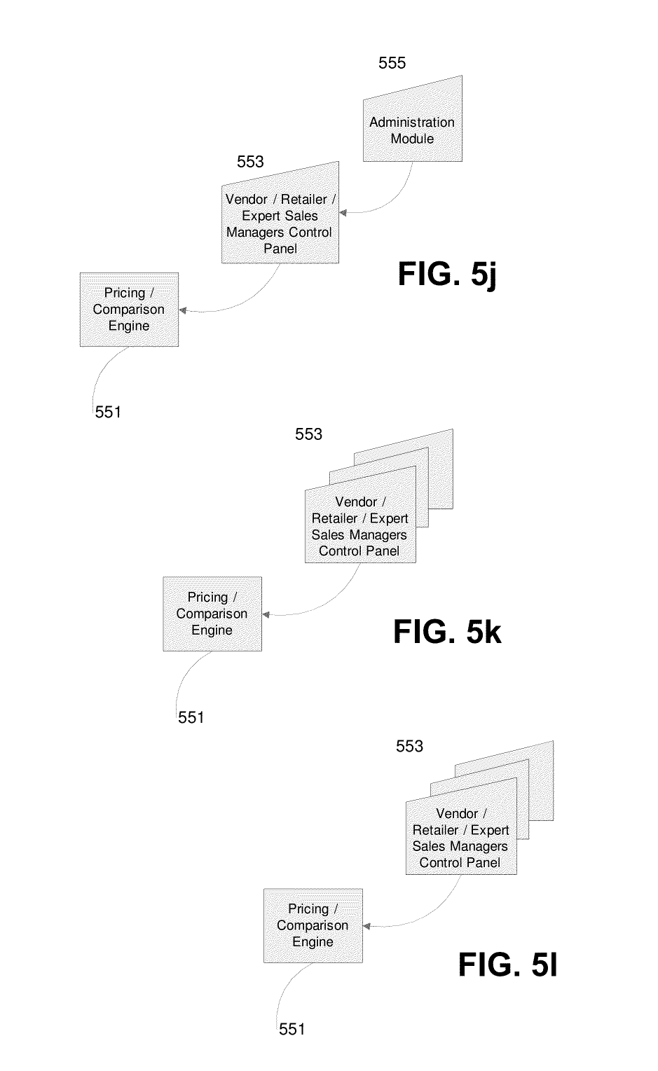

As shown in FIG. 5a, vendor-created bundles 501 are pre-configured by the vendor based on its objectives, including with respect to margins, sales volumes (e.g., as to particular transactions, goods, customers or overall volumes), competitiveness with market alternatives, and/or inventory reduction using the control panel 503, product information, market information, the catalog information 505 and algorithms designed to achieve various alternative business objectives. For example, to move obsolete or dated inventory, vendor might price a complete dorm room bundle with last year's model of microwave less than a comparable bundle with more current microwaves. Each bundle may be presented as a single entity with a single price. Additionally, at the vendor's option, the prices of the individual items in the bundle may or may not be shown. Not showing the prices would focus the customer on the overall price and aggregate savings, rather than on the prices and savings of individual items.

FIG. 5a shows a high level workflow diagram of vendor-created bundles in the context of a dynamic bundle system. The vendor maintains catalogs of goods and or services 505. The term “vendor catalogs” used throughout the present disclosure may refer to and include goods and services that a customer sells from its own inventory or enterprise and/or goods and services that the vendor sells using others to provide fulfillment. The vendor uses a control panel 503 to create bundles from its catalogs. More specifically, the vendor is able to log in to the control panel 503 to manage the structure of bundles and set the objectives to be achieved in formulating and pricing the bundles, a shopping and transaction module whereby the customer purchases the bundled products, and a pricing engine module (e.g., as shown in FIG. 5k) determines the price for the selected bundle based on algorithms and objectives selected by the vendor.

In operation of embodiment of FIG. 5a, the customer is able to select from vendor-created bundles 501 that are based on generally available web based vendor catalogs 505 where the bundle is presented on a customer interface with product descriptions and total price for the bundle. For example, a vendor could provide one or several bundles, each containing products that may be needed by a student (e.g., under bed storage, alarm clock, shower caddy, etc.) for a set price that reflects a discount from the total price of the individual items if they were purchased separately. Prices of each bundle created by the vendor may vary automatically based on who the customer is (e.g., group membership) and where the customer came from.

Once a vendor-created bundle is accepted, goods may be purchased using a shopping cart. In one embodiment, prices may be reduced by a discount or a coupon code that has been generated to reflect additional discounts based on the rules defined by the vendor. These additional discounts may reflect the particular customer's characteristics (such as loyalty programs or previous purchases) or a group to which the customer belongs or a referring website, individual, social media location or other location from which the customer came.

### Section I:B—Customer-Created or Modified Bundles:

FIG. 5b shows a high-level workflow diagram of customer-created or modified bundles. Customers create bundles on a real-time basis from vendor's catalog 505 or change a vendor-created bundle 501, pre-determined by the vendor as discussed above. Each bundle proposed by the customer may be priced automatically or otherwise by the pricing engine and the price for each bundle may be displayed for the customer on a real-time basis. At the option of the vendor, the system can advise the customer of the reason for significant changes in the bundle price resulting from the removal, addition or replacement of a product. In the present ski-wear example, if the bundle is relatively low-price as the result of the inclusion of last year's model of ski pants, the system can advise the customer that the price will go up if the ski pants are changed and further that the increase can be avoided or mitigated if the customer includes in the bundle specified alternative ski pants. In so doing, the system may present the customer with alternatives that may be lower in list price or may also constitute out-of-date inventory comparable to the vendor's selected bundle.

The pricing for any bundle reflects decisions having been made by the vendor using the control panel 503, based on algorithms and objectives selected by the vendor. As discussed above, the vendor can use the control panel 503 to set the objectives to be achieved in pricing the bundles. A dynamic bundle system may utilize the same types of shopping and transaction modules to facilitate the customer purchases.

The customer may electronically access product information contained in vendor catalogs 505 through the Internet or other interfaces, including product descriptions and the total price for the bundle. While on vendor's web site or through another interface, the customer may create a bundle, on a real-time basis, based on his or her own specific choices, and that bundle is referred to as a “customer-created bundle”. In the present example, in choosing from vendor's wide range of ski-related products in vendor's catalog, the vendor may elect to bundle only ski poles and skis rather than a more complete bundle.

Customers also may modify, on a real-time basis, the contents of a vendor-created bundle 501 to suit their needs, thus creating a customer selected bundle 507. In the present example, customer could accept the bundle but change the brand or style of skis. This change may result in a change in the price of the bundle. Alternatively customers may create their own customized customer-created bundles from the vendor catalog.

Prices of each bundle (whether created by the vendor or created or modified by the customer) may vary based on who the customer is (e.g., group membership) and where the customer came from.

Once the customer accepts the price for a customer-created or modified bundle and chooses to purchase it, goods may be purchased using a shopping cart. Prices may be reduced by a discount or a coupon code that has been generated to reflect additional discounts based on the rules defined by the vendor. These additional discounts may reflect the particular customer's characteristics (such as loyalty programs or previous purchases) or a group to which the customer belongs or a referring website, social media location or other location from which the customer came.

### Section I:C—Concierge Bundles

FIG. 5c illustrates a concierge bundle system. Through an interface the customer provides the vendor with a list of specific items (by product name, serial number, sku, UPC, or other identifier) for the bundle. Vendor's system essentially acts as a “concierge” to locate the products and evaluate the customer entered price (if any) for the bundle. The interface 507 enables the customer to select from existing indexed searchable vendor catalogs 505, product identifiers (i.e., sku, UPC, ISBN, etc.) 506, or product description information 508. Product information may come from catalogs, the website, manufacturers' websites, or other third-party websites, or a combination. Optionally, the system could permit the customer to specify a price, price range, or a maximum price for the specific items. (E.g., “I will buy this list of particular home entertainment components for $1,500.”) where the vendor sources some or all of the items from third-party suppliers, the vendor may use the comparison engine to evaluate bids from suppliers. The vendor's system fulfills the listed items automatically from either its own catalog or from third-parties (in whole or in part) or both. The concierge bundle can be used in an automated system that performs pricing and presentment almost immediately after the customer submits to the vendor the proposed bundle (whether for specific items or using specifications) or changes to a proposed bundle. In one embodiment, aside from setting the pre-determined rules, human involvement by the vendor may not be required to price a concierge bundle.

Section I:D—Concierge Bundles from Specifications:

Through an interface the customer provides the vendor 509 with a list of specifications and/or attributes 511 (rather than the names of specific products) for various items that would comprise a bundle. In some cases, the customer may provide the vendor with a combination of specifications and specific products. Optionally, the system could permit the customer to specify a price or a maximum price for bundles that conform to the stated specifications or attributes.

FIG. 5d shows a high level workflow diagram of a concierge bundle from specifications. The concierge bundle system enables a customer to submit a list of multiple goods, or a set of specifications or characteristics for multiple goods, to a vendor, for proposed fulfillment and/or pricing. The vendor may fulfill a request with items from its own catalog, from third-parties (bidding as to some or the entire bundle) or a combination thereof. The system can assist the customer in determining the customer's specifications and/or suggest products on a real-time basis that would meet the customer's requirements. In addition, if the customer is purchasing the bundle to comprise a system, such as a home entertainment system, the vendor's system could suggest other items that may be needed for a complete system.

For example, a customer desiring a home entertainment system could request proposals for the following: “60′ plasma, 5 channel surround sound, a digital receiver with at least 75 watts, etc. for a 20×30 room.” The customer may insert these or other specifications and submit them to the system for sourcing. Or the customer may insert certain specifications (e.g., 10 feet of HDMI cable) and select a specific item (Sony Blu-ray model number). The system may then make suggestions and provide information, such as to products or categories, as the customer prepares the list. Once the customer has completed the parameters for the bundle, it is submitted to the vendor's system, which sources items from its catalog or third-parties or a combination and provides one or more bundles that satisfy the customer's specifications. Optionally, the system could permit the customer to specify a price or a maximum price for bundles that conform to the stated specifications or attributes. (E.g., “i will buy a home entertainment system meeting these specifications for $1,500.”) Where the system sources some or all of the items from third-party suppliers, the vendor may use the comparison engine to evaluate bids from suppliers. The vendor's system fulfills the listed items automatically from either its own catalog or from third-parties (in whole or in part) or both. The concierge bundle can be used in an automated system that performs pricing, comparison and presentment almost immediately after the customer submits to the vendor the proposed bundle (whether for specifications only or for a combination of specific items and using specifications) or changes to a proposed bundle. Aside from setting the pre-determined rules, no vendor action is required to price a concierge bundle.

### Section I:E—Pop Up Recommendation Lists:

FIG. 5e illustrates an embodiment of a pop-up recommendation list (PURL). The customer is presented with an initial pop up recommendation list (PURL) of product and services recommendations while using an external system 521 such as (without limitation) a sponsor portal such as: a site for blogging, social network, e-commerce, texting, Tweeting, micro-blogging or other external application. The PURL 523 is a bundle proposed by a sponsor, such as a vendor, blogger or “expert” (the “sponsor”), who may benefit, monetarily or otherwise, from the sale of some or all of the items in the PURL. The sponsor can create, in advance or on a real-time basis (either manually or using artificial intelligence) in response to communications with prospective customers. Customer interactions to change the PURL, if permitted by its sponsor, are essentially the same as a customer-modified bundle. Optionally, a consumer may communicate 529 with an expert to provide additional information or answer questions. The sponsor can also manually intervene to create changes to PURLs in response to interactions with customers, such as while blogging and commenting. Customer interactions with PURLs (after created by a sponsor) may be automated and occur on a real-time basis. For example, a sponsor, who is an expert in home entertainment systems, could make a list of recommended components that comprise a moderately-priced home entertainment system. At the sponsor's option, the products and services included in the PURL could be priced, like other bundles, on an aggregate basis.

The customer can take an action to access a PURL, such as by clicking on an icon or linked text, or requesting a recommendation while using the external application. The PURL is presented within the context of the site or application function and acts as a starting point to execute the PURL. This process initiates the request for bundle information and facilitate the subsequent modifications to the PURL, either by the customer in a manner similar to a customer-modified bundle or by the sponsor (either manually or using artificial intelligence) on a real time basis. The artificial intelligence could sense the direction of a conversation between the customer and the sponsor (including as one of the bloggers, Tweeters, chat room participants, social networkers, commenters, etc.) and generate more responsive PURLs. For example, if the context is a blog focused on Cabernet wines, but the conversation turns to Malbecs, the PURL system could substitute or generate (based on pre-determined business rules) a new or different PURL.

It should be noted that the sponsor of the PURLs and customers finding the PURL may be able to access much of the core functionality of an e-commerce site without the customer having to going to a site and without the sponsor having to maintain a site. The customer may access the PURL wherever the customer is, such as on a blog. The customer can view the list, make purchases of some or all of the items of the list and possibly even make changes to the list without leaving the customer's location. The sponsor can present lists of recommendations without having to operate its own web site. The goods and/or services that comprise the lists can be hosted by a third-party, in which event the PURL is essentially a link to a list of goods and/or services, with an e-commerce back-end hosted by the third-party. Any expert can become a sponsor by registering on the server's site and thereafter log into that site to create or modify PURLs.

### Section II—Fulfillment

With respect to the elements and systems described herein, a vendor or sponsor can fulfill any bundle (including a PURL bundle) from its own catalog (e.g., see FIG. 5f), from third-parties, or a combination. In a concierge bundle, which is defined as a bundle created by the vendor based on the expressed wishes of the customer, the vendor's system is more likely to source the bundle, at least in part, using third-parties, particularly where the customer defines the bundle in whole or in part by virtue of specifications. The fulfillment elements are as follows: fulfillment from vendor's catalog; and bundle fulfilled by third-parties, including whole concierge bundles fulfilled by multiple parties and partial concierge bundles fulfilled by multiple parties.

Section II:A—Fulfillment from Vendor's Catalog:

In one embodiment, the vendor may directly pick and ship (i.e., fulfill) orders from its own inventory as listed in its own catalog 535. In this case, third-party vendors are not needed.

### Section II:B—Bundle Fulfilled by Third-Parties:

In some embodiments, a vendor or sponsor may desire to fulfill the goods and services comprising a bundle through third-parties or a combination of its own catalog 535 and those of third-parties, including vendor-created or customer-created bundles, concierge bundles and PURLs, as illustrated by FIG. 5g.

After a customer submits a request for a bundle, in one embodiment, the system (based on rules employed by the vendor) automatically and electronically submits the parameters for the bundle or portions of the bundle to suppliers or other retailers, for bids with respect to all or some of the goods in the bundle. Some or all of the suppliers may have pre-existing relationships with the vendor. In other embodiments, the bids may be posted electronically on a site or location where interested bidders can be notified of proposed bundles and submit bids. Integrated vendors may be those that have data format mappings and commercial terms established in regards to costs and shipping charges. Non-integrated vendors are those whose products have been proposed for or included in the bundle but an electronic submission process or special pricing has not been established. All communications of proposed bundle products or specifications, and all bids in response thereto, may be communicated electronically, and on a real-time, almost instantaneous basis (i.e., within a reasonable time after the bundle is submitted or proposed), except where the vendor otherwise elects.

Section II:B1—Whole Concierge Bundles Fulfilled by Third-Parties:

In one embodiment having a whole concierge bundle fulfilled by a third-party, the comparison engine may compare different bids from various vendors on the entire bundle and present them to the customer. In case, the customer selects a preferable bid to be fulfilled by the third-party.

### Section II:B2—Partial Concierge Bundles Fulfilled by Third-Parties:

In one embodiment having a partial concierge bundle fulfilled by a third-party, the comparison engine may compare different bids from various vendors on certain pieces or portions of the bundle and present them to the customer. The system of the present disclosure will evaluate the separate bids and piece them together to present the bundle to the customer for the customer to select a preferable bid to be fulfilled by the third-party.

### Section III: Administration Module (Control Panel)

As illustrated in FIG. 5j, an administration module 555 facilitates vendor's log-in to the control panel 553 in order to manage access rights to vendors that may then be able to log in to manage the structure of bundles and set the objectives to be achieved in formulating and pricing the bundles. The control panel 553 refers to a group of tools made available to vendors that may be used to manage the structure of bundles, assess the competitiveness of the proposed bundle price with market pricing, model the profitability and availability of bundles and apply the pricing rules for the pricing engine 551. In one embodiment, vendors may be able to establish rules by use of the control panel 553, which may govern the pricing presented to the customer for a bundle whether created by vendor or created by the customer. Rules may be established based on multiple criteria managed by the vendor. In combination with the vendor's database of product costs, the vendor's product catalog may provide product information and regular pricing in order to create and model the bundles. The control panel 553 provides a modeling tool so the vendor can determine if a bundle meets the objectives of the vendor. The control panel 553 may enable the vendor to control the timing of when a specific bundle (or sub-components) may be available for selection by customers. In one embodiment, the control panel 553 may also enable the vendor to apply special rules and/or additional discounts to particular customers or types of customers.

### Section IV: Pricing Engine and Comparison Engine

### Section IV:A—Pricing Engine

The pricing engine 551 as illustrated in FIG. 5k determines the price of a bundle 551, using pricing rules algorithms. The vendor uses a control panel 553 for the pricing engine to set objectives for its bundles and, if desired by the vendor, modify the output of the pricing engines for specific bundles (including if a vendor desires to implement an objective for a particular bundle that happens to be contrary to the vendor's usual rules). Together, the pricing rules algorithms and stated objectives enable the vendor to optimize the pricing for bundles created by vendor or created or modified by customers, based on what vendor wants to accomplish. Examples of vendor objectives are: maximizing gross margin per customer or per item or per order, maximize revenues or profits per customer or overall revenue or profits, providing better overall prices than those of competitors, increasing market share, selling obsolete or outdated inventory; attracting new customers, etc. Accordingly, pricing algorithms may include promotional, marginal, inventory, unit volume, shipping and handling elements, among others. There are many different possible vendor objectives which the pricing engine would facilitate.

FIG. 5k shows a high level workflow diagram of the pricing engine 551. The pricing engine process 551 is the center of the process that applies the directives of the vendors to the bundle of goods created by vendor or created or modified by the customer. Vendors may use the control panel 553 to set their objectives. The pricing engine 551 is configured to determine the price of each bundle using pricing rules algorithms. Transaction elements may be logged to track the bundle composition and customer response for each interaction. Data from such tracking may include without limitation data concerning a customer's reaction to changes in prices resulting from the customer's changes in the bundle and may inform strategies for creating bundles to increase the likelihood that a customer will purchase a particular bundle or will react favorably to bundle prices. The price of the bundle may vary based on who the customer is and where the customer came from (e.g., group membership).

### Section IV:B—Comparison Engine

Referring to FIG. 5l, when a customer proposes a bundle of particular goods or a list of specifications of goods or services, whether or not the customer also proposes a price, maximum price, or price range for the bundle of goods and/or services associated with the proposal, the vendor and one or more third-party suppliers may propose goods and/or services to fulfill some or all of the proposal, such as in the case of whole concierge bundles fulfilled by multiple parties or partial concierge bundles fulfilled by multiple parties. The comparison engine 551 may be used for evaluating multiple bids from the vendor and one or more third-party suppliers. The comparison engine 551 uses artificial intelligence to evaluate multiple bids, some of which may be partial and some of which may be complete, to determine which bid or bids to offer the customer, evaluate (and take into account) the characteristics (such as reliability and reputation) of particular bidders, and to determine the suggested price of each bundle offered to the customer. The customer receives one (or more) bundles and a price for each in response to the customer's proposal. Often the customer may not know that one or more of the suggested bundles may be fulfilled by multiple vendors. The comparison engine is configured to also take into account the price or maximum price proposed by the customer.

In one embodiment, the comparison engine 551 may be managed by the vendor through the control panel 553. The comparison utilizes a multiple criteria driven comparison managed by vendor through the control panel 553. Multiple interfaces may be used to get pricing, availability, shipping/handling costs from vendor in real time or through stored product information. Some criteria may be stored as inputs to the decision process including but not limited to: supplier ratings, shipping costs, drop ship charges, availability of product, delivery constraints, or other criteria. Multi-level product information facilitates ranking and comparison of similar but different products within a specific range.

### Section V: Bundle Evaluation (Market Test) Engine

As stated herein, vendors may create bundles to achieve business objectives, such as maximizing the profit on the entire order, promoting a label, moving aging inventory or creating more value for the customer. Pricing may be determined automatically, on a real-time basis, by the pricing engine, based on proprietary algorithms and vendor's objectives.

The ability of the pricing engine to price a bundle is enhanced by market test functionality. Ordinarily the vendor measures the strength or appeal of a bundle based on the vendor's own product cost structure. But if the costs on certain items are relatively high, the merchant may believe that a bundle with, say, a low overall margin is a better bargain than customers would perceive it to be. As the vendor creates the bundle, the market test engine conducts a search of the Internet, and optionally other databases, to compare the prices of individual items in the bundle and the bundle as a whole to the aggregate bundle price that the vendor expects to provide. In so doing the market test engine can indicate the strength of the bundle, including as to whether the bundle price is favorable relative to prices in the marketplace for the same or similar individual items or the entire bundle. The market test engine may warn the vendor as to the risks that a customer would “cherry pick” specific items to exclude them from the bundle and purchase them elsewhere individually in order to save money. For example the market test engine may determine the implicit price of an item (subtracting the price of a bundle without the item from the price of the bundle with the item) and compare the implicit price with the actual market price. The market price engine may also take in to account the reputation and strength of various other suppliers referenced in the market test.

Similarly, as customers vary the bundles or create their own customized bundles, the market test engine may assist the pricing engine to determine prices that are as aggressive as the merchant needs to be, to provide a competitive bundle.

One should note that conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more particular embodiments or that one or more particular embodiments necessarily include logic for deciding, with or without user input or prompting, whether these features, elements and/or steps are included or are to be performed in any particular embodiment.

It should be emphasized that the above-described embodiments are merely possible examples of implementations, merely set forth for a clear understanding of the principles of the present disclosure. Any process descriptions or blocks in flow diagrams should be understood as representing modules, segments, or portions of code which include one or more executable instructions for implementing specific logical functions or steps in the process, and alternate implementations are included in which functions may not be included or executed at all, may be executed out of order from that shown or discussed, including substantially concurrently or in reverse order, depending on the functionality involved, as would be understood by those reasonably skilled in the art of the present disclosure. Many variations and modifications may be made to the above-described embodiment(s) without departing substantially from the spirit and principles of the present disclosure. Further, the scope of the present disclosure is intended to cover any and all combinations and sub-combinations of all elements, features, and aspects discussed above. All such modifications and variations are intended to be included herein within the scope of the present disclosure, and all possible claims to individual aspects or combinations of elements or steps are intended to be supported by the present disclosure.

What is claimed is:

1. A computer-implemented method comprising steps of:
providing sponsor content by a sponsor to an electronic system that is external to any e-commerce system operated by the sponsor;
presenting the sponsor content to at least one individual interacting with the electronic system;
creating, automatically by a computer, for the individual interacting with the electronic system to which the sponsor content is presented, at least one pop-up recommendation list (PURL) that includes information referring to a plurality of items recommended to the individual;
presenting, automatically by the computer, to the individual, information regarding a plurality of items recommended to the individual in the PURL; and
enabling, by the computer, the individual to purchase at least one of the plurality of items recommended to the individual in the PURL.

2. The method of claim 1, wherein the plurality of items recommended in the PURL is determined by the computer based on contextual references.

3. The method of claim 1, wherein the plurality of items recommended in the PURL are determined by the computer based on interactions between the individual and the sponsor content.

4. The method of claim 1, wherein the individual is enabled to modify the PURL while accessing the system where the sponsor content is provided.

5. The method of claim 1, wherein the individual is enabled to search for a PURL on the system where the sponsor content is provided.

6. The method of claim 1, wherein the individual is enabled to initiate the presentation of a PURL, from the system where the sponsor content is provided.

7. The method of claim 1, wherein the individual is enabled to consummate the purchase of the at least one item of the PURL from the system on which the PURL was presented to the individual, without being transferred to an e-commerce system, wherein such consummation includes payment and transaction processing.

8. The method of claim 1, wherein the individual is enabled to consummate the purchase of the at least one item of the PURL after being directed from the system on which the PURL was presented to the individual to an e-commerce system of the at least one vendor to fulfill the individual's purchase, wherein such consummation includes payment and transaction processing and fulfillment.

9. The method of clam 1, wherein a third party hosts the system on which the at least one sponsor publishes content and presents PURLS.

10. The method of claim 9, wherein the third party provides to the at least one sponsor, catalog, payment and transaction processing, and fulfillment services respecting purchases by individuals to whom PURLS are presented.

11. The method of claim 1, further comprising providing an administrative module adapted to enable the sponsor to:
establish rules to be applied by the computer to modify the at least one PURL in response to the actions of an individual,
establish rules to be applied by the computer to price each PURL,
manage creation, publication and presentation of PURLS,
manage data respecting PURLs that have been created,
manage communications with individuals,
facilitate modification of at least one PURL in response to actions of individuals, and
evaluate profitability and other economic attributes of each PURL.
